(19) United States
(12) Patent Application Publication
(10) Pub. No.: US 2010/0306646 A1
(43) Pub. Date: Dec. 2, 2010

(54) IMAGE PROCESSING APPARATUS AND COMPUTER-READABLE STORAGE MEDIUM

(75) Inventor: Tomoko Fukase, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/786,908

(22) Filed: May 25, 2010

(30) Foreign Application Priority Data
May 26, 2009 (JP) 2009-126140

(51) Int. Cl. G06F 17/00

(52) U.S. Cl. 715/274

(57) ABSTRACT

There is disclosed an image processing apparatus to preview an image to be printed, the image processing apparatus including: an input section to receive an instruction to preview a next image; and a control section to specify an image to be previewed next based on the instruction input through the input section, wherein the control section detects a page for which a print setting content is different from a print setting content for the page of a currently-previewed image among a plurality of pages included in print data to determine the image to be previewed next according to a detected result.

### CROSS-REFERENCE TO RELATED APPLICATION

The present U.S. patent application claims a priority under the Paris Convention of Japanese patent application No. 2009-126140 filed on May 26, 2009, which shall be a basis of correction of an incorrect translation.

### BACKGROUND

1. Field of the Invention

The present invention relates to an image processing apparatus and a computer-readable storage medium.

2. Description of Related Art

When performing image formation (hereinafter referred to as “printing”) by an image forming device such as a printer, it is possible to perform a preview in which a printing result with respect to a print medium such as paper is simulated to be displayed before printing.

Generally the first page is firstly previewed when a plurality of pages are printed. Then, subsequent pages are sequentially previewed according to paging instructions input by a user.

Such preview can be performed by using a preview display function contained in a printer body, or by an image processing apparatus such as a computer which outputs data (hereinafter referred to as “print data”) of an image to be printed to a printer.

Equipment having a preview function generally has a function to instruct to print a previewed page so that a user can easily confirm a printing result of the page being currently previewed.

When printing a plurality of pages, there is a case that a user wants to change a setting content for printing some pages to be different from that for other pages. As such case, for example, a case of printing data containing both of a monochrome image and a color image, and a case of intending to change sheets to be used for printing some pages may be cited. Hereinafter, a setting content for printing is referred to as “print setting”.

As a conventional previewing method in printing where the print setting for some pages is different from that for other pages, there has been known a method for previewing only pages which meet a specific condition. For example, there has been known a method for judging whether or not each page is targeted for the preview based on the setting content such as presence or absence of a punch hole in the sheet and a minimum value of a margin so as to preview only the preview target pages (Japanese Patent Application Laid-open Publication No. 2008-229851).

However, since only pages which meet a specific condition are simply previewed by the method described in Japanese Patent Application Laid-open Publication No. 2008-229851, other pages which do not meet the specific condition are not previewed. Moreover, by the method described in Japanese Patent Application Laid-open Publication No. 2008-229851, when there is a plurality of pages which meet the specific condition, all of the pages are targeted for preview displaying, but even when there are some differences among print settings of the plurality of pages, such differences are not considered.

The inventors found a tendency of printing in which the print setting for some pages is different from that for other pages to easily cause an error that the print setting for a page which becomes a turn of the print setting, or for a previous/next page thereof, becomes a different print setting from an originally desired print setting. Such error usually occurs by wrongly specifying the page to be the turn of the print setting. However, the method described in Japanese Patent Application Laid-open Publication No. 2008-229851 cannot always confirm the turn of the print setting by the preview.

### SUMMARY

The prevent invention has been achieved in view of the abovementioned problems, and the object of the present invention is to pick up as a preview target a page for which a print setting is expected to be wrongly set when printing is performed based on print data including a plurality of pages.

To achieve at least one of the abovementioned objects, according to one aspect of the present invention, there is provided an image processing apparatus to preview an image to be printed, the image processing apparatus including: an input section to receive an instruction to preview a next image; and a control section to specify an image to be previewed next based on the instruction input through the input section, wherein the control section detects a page for which a print setting content is different from a print setting content for the page of a currently-previewed image among a plurality of pages included in print data to determine the image to be previewed next according to a detected result.

Preferably, in the image processing apparatus, the control section determines as the image to be previewed next an image of a first page for which the print setting content is different from the print setting content for the page of the currently-previewed image among a series of pages after the page of the currently-previewed image.

Preferably, in the image processing apparatus, the control section determines as the image to be previewed next an image of a previous page of the first page for which the print setting content is different from the print setting content for the page of the currently-previewed image among a series of pages after the page of the currently-previewed image.

Preferably, in the image processing apparatus, the control section determines as the image to be previewed next an image of a last page for which the print setting content is different from the print setting content for the page of the currently-previewed image among a series of pages prior to the page of the currently-previewed image.

Preferably, in the image processing apparatus, the control section determines as the image to be previewed next an image of a first page for which the print setting content is same as the print setting content for a last page for which the print setting content is different from the print setting content for the page of the currently-previewed image among a series of pages prior to the page of the currently-previewed image, there being no page for which the print setting content is different from the print setting content for the last page between the last page and the first page.

Preferably, in the image processing apparatus, the input section enables an input of an instruction to set a flag or to delete an already-set flag to one or a plurality of pages included in the print data based on the page of the currently-previewed image, and the control section performs print processing of the image of the page included in the print data based on the flag.

### BRIEF DESCRIPTION OF THE DRAWINGS

The present invention will become more fully understood from the detailed description given hereinbelow and the appended drawings, and thus are not intended as a definition of the limits of the present invention, and wherein;

FIG. 1 is a block diagram showing a main configuration of a MFP including an image processing apparatus according to an embodiment of the present invention;

FIG. 2 is a diagram showing an example of a network configuration including the MFP;

FIG. 3 is a schematic diagram showing an exterior appearance of the MFP of the embodiment;

FIG. 4 is a diagram showing an overview of ticket information;

FIG. 5 is a diagram showing an example of composition of job information;

FIG. 6 is a diagram showing an example of composition of page information;

FIG. 7 is an explanatory diagram showing an example of print setting confirmation screen 130;

FIG. 8 is an explanatory diagram of an example showing a page transition rule by paging buttons 141-144;

FIG. 9 is an explanatory diagram of an example showing a page transition rule by paging buttons 145-148;

FIG. 10 is an explanatory diagram of an example showing a rule of flag setting by check buttons 151-153;

FIG. 11 is a flowchart showing a flow of processing by the MFP to which a print job has been transmitted;

FIG. 12 is a flowchart showing a flow of preview switching processing of Step S9 shown in FIG. 11;

FIG. 13 is a flowchart showing a flow of page switching processing A of Step S25 shown in FIG. 12;

FIG. 14 is a flowchart showing a flow of page switching processing B of Step S26 shown in FIG. 12;

FIG. 15 is a flowchart showing a flow of page switching processing C of Step S27 shown in FIG. 12;

FIG. 16 is a flowchart showing a flow of page switching processing D of Step S28 shown in FIG. 12;

FIG. 17 is a flowchart showing a flow of trial print processing of Step S16 shown in FIG. 11;

FIG. 18 is a flowchart showing a flow of trial print processing of all “already-checked” pages of Step S95 shown in FIG. 17;

FIG. 19 is a flowchart showing a flow of trial print processing of “already-checked” and “unprinted” pages of Step S96 shown in FIG. 17;

FIG. 20 is a flowchart showing processing when an input instruction has been performed on any of check buttons 151-153;

FIG. 21 is a flowchart showing a flow of flag setting processing A of Step S125 of FIG. 20; and

FIG. 22 is a flowchart showing a flow of flag setting processing B of Step S26 of FIG. 20.

### DETAILED DESCRIPTION OF THE PREFERRED EMBODIMENT

Hereinafter, the embodiments of the present invention will be described as an example in detail with reference to the drawings. A term “image” to be hereinafter described contains a displayed image by a display device, and all formed images including characters, symbols, graphics, pictures, photographs and combinations thereof to be formed on a print medium by an image forming device.

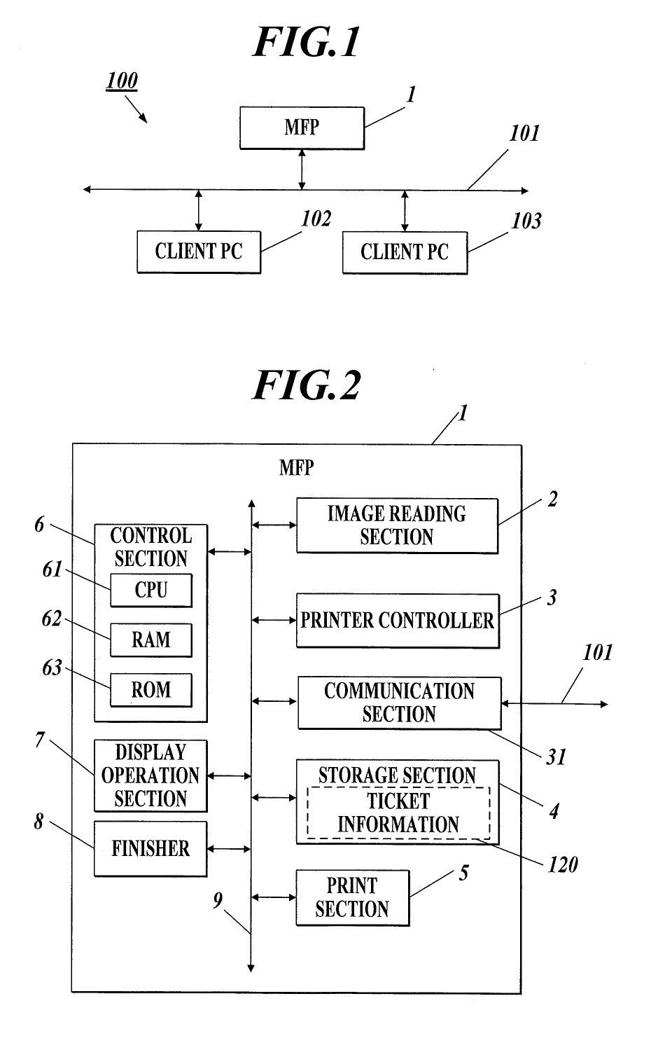

FIG. 1 is a diagram showing a configuration example of an image forming system 100 equipped with a Multi-Function Peripheral (MFP) 1.

As shown in FIG. 1, the image forming system 100 allows client PCs 102, 103 and the MFP 1 to communicably connect to one another through a line 101.

The client PCs 102, 103 transmit print jobs each including print data to be printed to the MFP 1.

The MFP1 performs printing and various processings related to printing based on the received print job.

FIG. 2 is a block diagram showing a main configuration of the MFP equipped with the image processing apparatus according to one embodiment of the present invention.

The MFP 1 includes an image reading section 2, a printer controller 3, a communication section 31, a storage section 4, a print section 5, a control section 6, a display operation section 7 and a finisher 8. The sections of the MFP 1 are connected to one another through a bus 9.

The image reading section 2 has a scanning function to read an image from a medium such as paper to make it into data.

The printer controller 3 performs rasterizing processing based on the print job received from external equipment to create raster data such as a bitmap image from the print data contained in the print job.

The communication section 31 functions as a network interface which connects the MFP 1 to the line 101, and receives data such as the print job transmitted from the external equipment.

The storage section 4 includes a rewritable nonvolatile storage device such as a hard disc and flash memory for example, and stores various pieces of data to be treated by the MFP 1. The data to be stored by the storage section 4 includes the abovementioned print job and the image data read by the image reading section 2, for example.

The print section 5 forms an image on a print medium such as paper. The print section 5 of the embodiment forms an image by an electrophotographic printing system by which a toner is transferred and heat-fixed on the print medium. The configuration of the print section 5 is not limited to the electrophotographic printing system. For example, an ink-jet device which ejects ink drops onto paper or the like, and configurations for printing which are used all sorts of printers such as a thermal transfer printer, thermal melting printer, thermal printer, and dot impact printer.

The control section 6 controls an operation of the MFP 1. The control section 6 includes at least a CPU 61, RAM 62 and ROM 63, and reads a program, data, and so on from the ROM 63 and/or the storage section 4 depending on a processing content to execute/process them so as to control an operation of each section of the MFP 1. The ROM 63 stores the program, data, and so on to be used in processing by the CPU 61. The RAM 62 functions as a main storage device in the processing by the CPU 61.

The display operation section 7 functions as a display device to display various pieces of information pertaining to the operation of the MFP 1, and also functions as an input device for various inputs to the MFP 1. The display operation section 7 of the embodiment adopts a touch panel system which enables inputting by a contact operation or pressing operation on a button and the like displayed in the display section. The configuration of the display section 7 is not limited to the touch panel, and may be configured by individually providing the display section and the input section, or by combining an input by the touch panel system and the input device which is separately provided.

The finisher 8 performs finishing to the print medium which has been image-formed and output by the print section 5. The finishing by the finisher 8 includes stapling, folding, and forming punch holes and the like, for example.

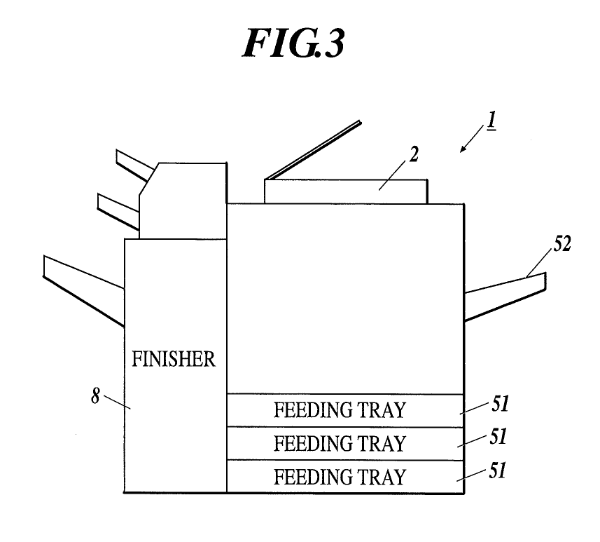

FIG. 3 is a schematic diagram showing an exterior appearance of the MFP 1 of the embodiment.

As shown in FIG. 3, the MFP 1 includes a plurality of feeding trays 51, 51, 51 so that papers to be print media can be stocked in each of the trays. The MFP 1 also includes a manual feeding tray 52 so that a user can manually feed papers.

The control section 6 determines from which tray paper to be image-formed is obtained based on a print setting content included in the print job.

Next, print processing by the MFP 1 which has received the print job will be described.

When the MFP 1 receives the print job transmitted from the client PC 102 or the client PC 103, the control section 6 analyzes the print job to read the print setting to store the read print setting as ticket information 120 in the storage section 4.

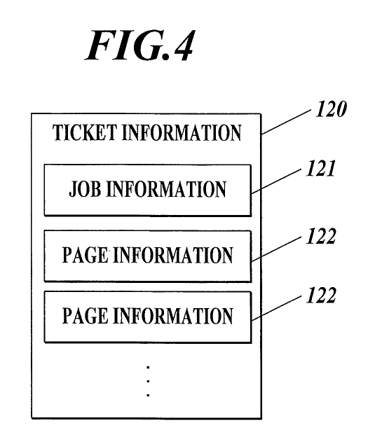

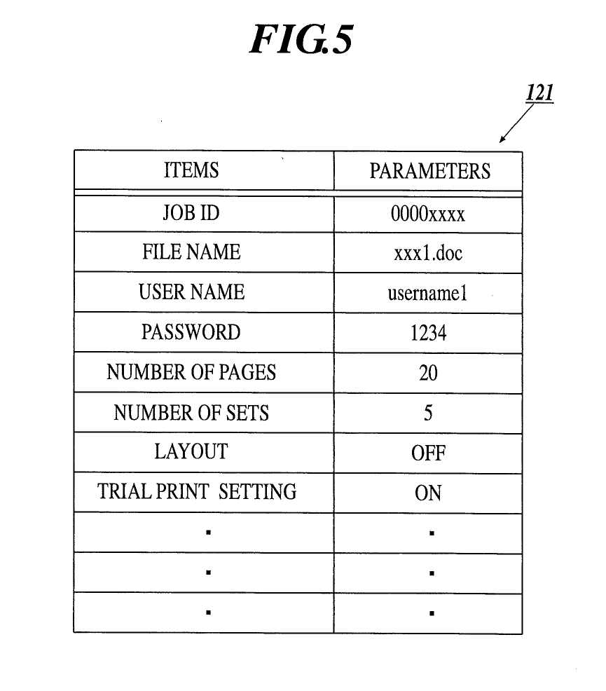

FIG. 4 is a diagram showing an overview of the ticket information 120.

The ticket information 120 includes job information 121 and page information 122.

FIG. 5 is a diagram showing an example of composition of the job information 121.

The job information 121 contains items of the print setting and parameters of the respective items to be applied to whole print data included in the print job. The items of the print setting to be applied to the whole print data include, for example, job ID, file name, user name, password, the number of pages, the number of sets, layout, trial print setting and the like. It is possible to appropriately add, change, or delete items depending on required matters for printing.

The job ID is an individual number to be given to the print job, and the job ID of each print job is different from that of other print jobs.

The file name is a file name of original document of the print data included in the print job.

The user name is a user name of the external equipment which has transmitted the print job. For example, a user name and the like logged in the client PC 102 or the client PC 103 which has transmitted the printer job becomes the user name of the job information 121.

The password is a character string to be used when some kind of authentication is required in the print processing. For example, the password is used when authentication is required for judging availability of transmission of the print job to the MFP 1 or for changing the print setting of the print job.

The number of pages indicates a total number of pages of the print data included in the print job.

The number of sets indicates the number of sets to be printed and output according to the print job.

The layout indicates information pertaining to a layout in printing. For example, the information pertains to whether or not edition for making a booklet is performed, whether or not creep processing is performed in making a booklet, where or not stapling is performed, a binding direction depending on a page turning over direction, and so on.

The trial print setting is a flag to indicate whether or not the print setting included in the job information and/or the page information has been entered. The trial print setting has a value indicating ON or OFF. In the embodiment, when the trial print setting is ON, the print setting included in the job information and/or the page information has not been entered, and when the trial print setting is OFF, the print setting included in the job information and/or the page information has been entered. An initial value of the trial print setting when the ticket information is stored in the storage section 4 is ON.

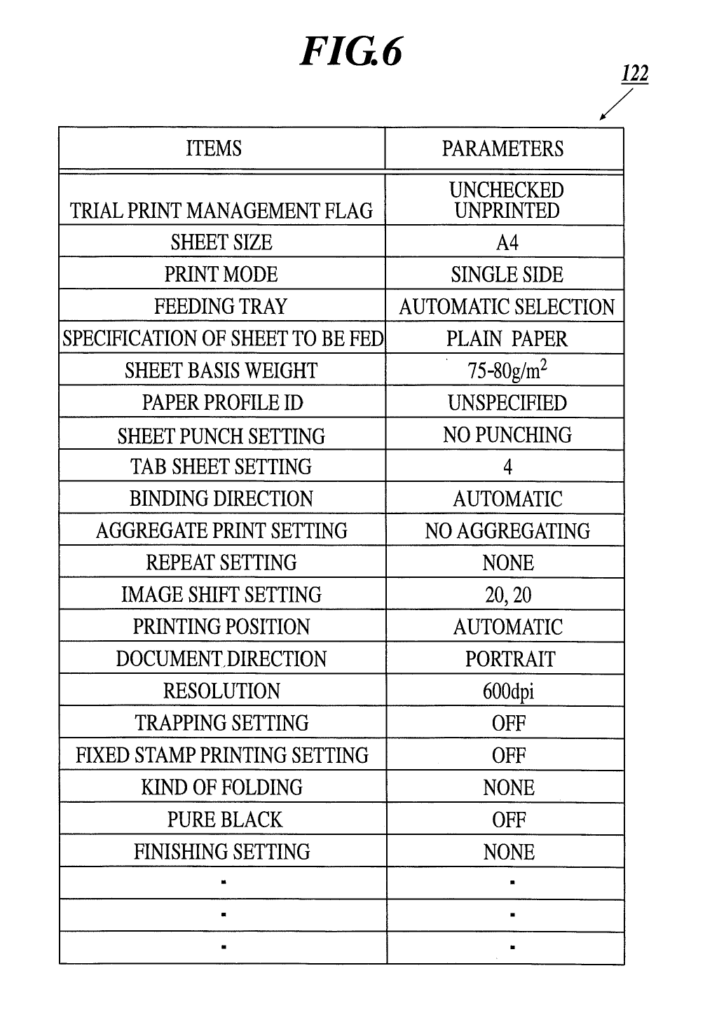

FIG. 6 is a diagram showing an example of composition of the page information 122.

The page information 122 contains items of the print setting and parameters of the respective items to be applied to each page of the print data included in the print job. The pieces of page information are provided individually depending on the number of pages of the print data included in the print job. In other words, the page information like that shown in FIG. 6 is set for each page.

The items of the print setting to be applied to each page of the print data by the page information include, for example, page number, trial print management flag, sheet size, print mode, feeding tray, specification of sheet to be fed, sheet basis weight, Paper Profile ID, sheet punch setting, Tab sheet setting, binding direction, aggregate print setting, repeat setting, image shift setting, printing position, document direction, resolution, trapping setting, fixed stamp setting, kind of folding, Pire Black setting, finishing setting, and so on. It is possible to appropriately add, change, or delete items depending on required matters for printing.

The page number is a number which correlates the page information to each page of the print data.

The trial print management flag is an item which has a flag for managing information pertaining to a trial print as a parameter.

The trial print management flag includes a parameter regarding presence or absence of the flag, and a parameter regarding accomplishment or attempt of printing. The parameter regarding presence or absence of the flag is indicated by one of “already-checked” and “unchecked”, and its initial value is “unchecked”. The parameter regarding accomplishment or attempt of printing is indicated by one of “already-printed” and “unprinted”, and its initial value is “unprinted”. The trial print will be described later.

The sheet size indicates a format of the paper (sheet) to be used in page printing.

The print mode indicates whether printing is performed on single side or both sides of the sheet. The control section 6 controls the print section 5 to perform printing on a side or sides specified in the print mode.

The feeding tray indicates from which feeding tray the sheet is obtained. In the case of “automatic selection”, the control section 6 performs processing to automatically select the feeding tray in which the sheets of appropriate size are stocked.

The specification of sheet to be fed indicates information pertaining to sheet material. For example, types of sheet such as plain sheet, high-quality sheet and color sheet may be cited.

The sheet basis weight indicates a weight of sheet per a predetermined area.

The Paper Profile ID is an ID indicating kind of sheet including the sheet size, the basis weight, and so on. The ID is previously determined for each kind of sheet, and the control section 6 can judge the kind of sheet to be used in printing based on a parameter of the Paper Profile ID. When the Paper Profile ID is not specified, the sheet to be used in printing is determined by parameters such as abovementioned sheet size, feeding tray, specification of sheet to be fed, sheet basis weight, sheet punch setting and Tab sheet setting.

The sheet punch setting indicates whether or not the sheet has a punch hole.

The Tab sheet setting indicates whether or not the sheet is Tab sheet.

The binding direction indicates a binding position of the sheet.

The aggregate print setting indicates whether or not images of a plurality of pages are aggregated to be printed on one sheet. For example, the cases of 2 in 1, 4 in 1, 8 in 1 and the like may be cited.

The repeat setting indicates whether or not a plurality of the same images are printed on one sheet. For example, the cases of 2-repeat, 4-repeat, rotation 2-repeat (right) and the like may be cited. The “n” of “n-repeat” indicates the number of the same images to be printed. The “rotation n-repeat (location)” indicates rotating the images of half the number of n by 180 degrees to print them on a side indicated by (location) of the sheet.

The image shift setting indicates information pertaining to margins in upper and lower sides, right and left sides, or both of them. In the embodiment, an upper margin and a left margin are indicated by setting as parameters two numerical values, which are comma-separated, of the upper margin and the left margin in that order. In this example, a unit thereof is [mm], but also [inch] or [cm] may be used.

The printing position indicates on which position of the sheet printing is performed. In the case of “automatic”, a default setting is used. The printing position also includes “leading end”, “center”, “posterior end” and the like. Printing is performed by using an upper-left portion as a reference in the case of “leading end”, by using a central portion as a reference in the case of “center”, or by using a lower-right portion as a reference in the case of “posterior end”.

The document direction indicates a direction of the sheet. Parameters of the document direction includes “Portrait” and “Landscape” for example, and printing is performed while making a long side of the sheet be along a lengthwise direction in the case of “Portrait”, or performed while making a short side of the sheet be along a lengthwise direction in the case of “Landscape”.

The resolution indicates a resolution of image formation in dpi.

The trapping setting indicates with ON/OFF whether or not trapping (processing for obscuring imperfect registration of printing machine by overprinting) is performed. In the case of ON, trapping is performed. In the case of OFF, trapping is not performed.

The fixed stamp setting indicates whether or not a fixed phrase or content according to a predetermined format to be printed regardless of print contents is printed. The contents indicated by the fixed stamp includes, for example, information for determining which of fixed stamps including character information such as page number, date, and time is printed, and information for indicating a printing position of the fixed stamp.

The kind of folding indicates kind of folding in the case that the sheet is folded. For example, an inward three-folding, outward three-folding, z-folding, gate-folding and the like may be cited.

The Pure Black setting indicates whether a black composed of only black (K) toner is used or a black composed of cyan (C), magenta (M) and yellow (Y) toners is used for printing a black portion.

The finishing setting indicates whether or not finishing is performed, and if finishing is performed, also indicates which of finishings is performed.

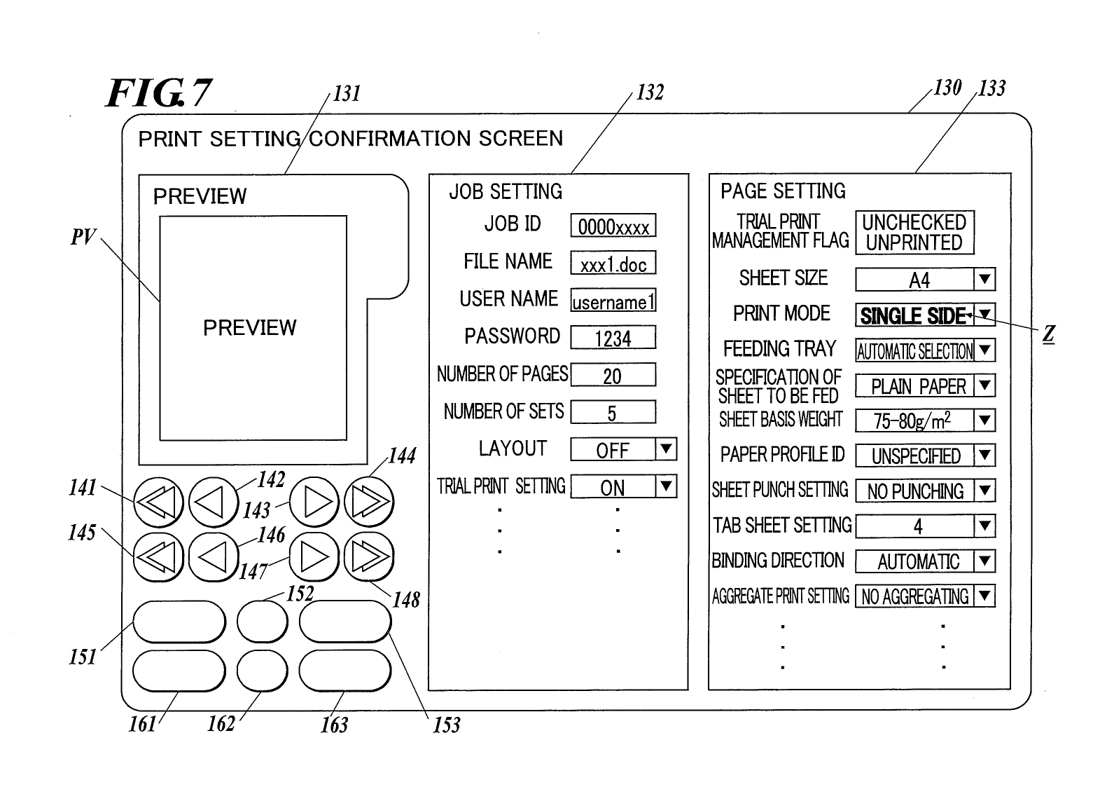

After storing the ticket information, the control section 6 performs rasterizing processing based on the ticket information, and creates a raster image. Then, the control section 6 creates an image for previewing the created raster image to store it in the storage section 4. This preview image is an image obtained by reduction (resolution reduction) of the raster image so as to fall within an after-mentioned preview frame 131 of the print setting confirmation screen 130 shown in FIG. 7.

The preview image is stored in the storage section 4 in the embodiment, but storing it in the storage section 4 is not always necessary. For example, it is also possible to store the created raster image in the RAM 62 of the control section 6 to read the raster image when needed so as to create a reduced preview image.

Then, the control section 6 creates a preview PV based on the preview image. The preview PV is obtained by editing the preview image based on the ticket information, and simulates an image to be formed on the print medium such as paper. As an example of editing based on the ticket information, for example, an image editing and the like for visually showing a state in which the fixed stamp has been given or finishing such as stapling, punching and the like has been performed may be cited.

The control section 6 allows the display operation section 7 to display the created preview PV. At that time, the control section 6 allows the display operation section 7 to display the print setting confirmation screen 130 so as to display the preview PV within the preview frame 131 of the print setting confirmation screen 130.

FIG. 7 is an explanatory diagram showing an example of print setting confirmation screen 130.

The print setting confirmation screen 130 includes paging buttons 141-148, check buttons 151-153, and trial print buttons 161-163.

The paging buttons 141-148 switches the preview PV displayed within the preview frame 131 of the print setting confirmation screen 130 to the preview PV of the image of other page. Each of the paging buttons 141-148 switches the preview PV according to a rule different from that of other button.

The paging button 141 allows to display the preview PV of the first page of data regarding the currently-displayed preview PV.

The paging button 142 allows to display the preview PV of a previous page of data regarding the currently-displayed preview PV.

The paging button 143 allows to display the preview PV of a next page of data regarding the currently-displayed preview PV.

The paging button 144 allows to display the preview PV of last page of data regarding the currently-displayed preview PV.

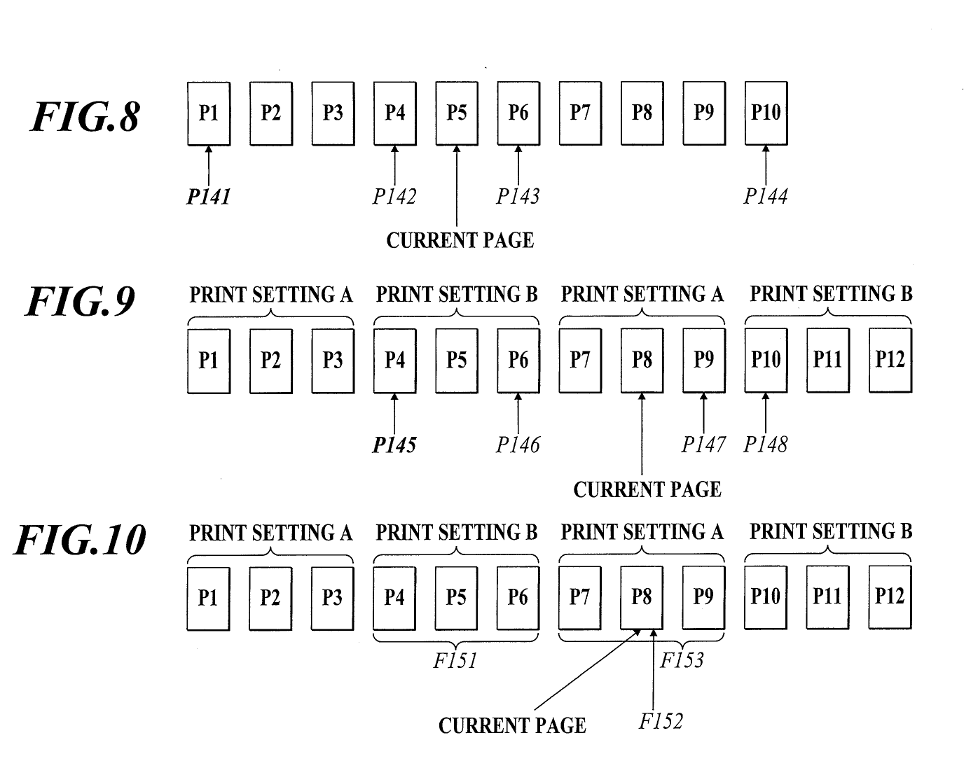

FIG. 8 is an explanatory diagram of an example showing a page transition rule by paging buttons 141-144.

With regard to FIG. 8 and an explanation using FIG. 8, an example where the print data of the print job input to the MFP 1 includes a total of 10 pages P1 to P10 and the currently-displayed preview PV is the preview of page P5 will be described.

When the paging button 141 receives the input instruction, the control section 6 performs processing to display the preview PV of page P1 within the preview frame 131 (P141 of FIG. 8).

When the paging button 142 receives the input instruction, the control section 6 performs processing to display the preview PV of page P4 within the preview frame 131 (P142 of FIG. 8).

When the paging button 143 receives the input instruction, the control section 6 performs processing to display the preview PV of page P6 within the preview frame 131 (P143 of FIG. 8).

When the paging button 144 receives the input instruction, the control section 6 performs processing to display the preview PV of page P10 within the preview frame 131 (P144 of FIG. 8).

The control section 6 performs processing to create the preview PV based on the preview image of page corresponding to the switched preview PV and the ticket information so as to switch display content within the preview frame 131.

In switching of the preview PV, there is a case that a user wants to confirm the preview PV of page for which the print setting is different from that for the currently-displayed preview PV. For example, there is a case that a user wants to confirm the preview PV of previous and/or next page of the page for which the print setting is changed. In such case, by performing the input instruction to any of the paging buttons 145-148, it becomes easy to confirm the preview PV based on the page number of the page whose print setting is different.

When any of the paging buttons 145-148 receives the input instruction, the control section 6 compares the page information of page of the currently-displayed preview PV with other page information. When any of the paging buttons 145, 146 receives the input instruction, the control section 6 compares the page information of the page of the currently-displayed preview PV with the page information of a series of pages prior to the page of the currently-displayed preview PV. When any of the paging buttons 147, 148 receives the input instruction, the control section 6 compares the page information of the page of the currently-displayed preview PV with the page information of a series of pages after the page of the currently-displayed preview PV.

By comparison of the pieces of page information, the control section 6 detects the page number of the page information which is different from the page information of the page of the currently-displayed preview PV, and determines the page of the preview PV to be displayed next based on the detected page number. In this regard, the control section 6 does not target a difference between the page numbers of the pieces of page information for the detection in the comparison of the pieces of page information. In other words, the control section 6 compares the parameter set in any of the items other than the page number included in each of the pieces of page information with that of other page information, and when a difference is detected between the parameters in the same item, it is judged that there is a difference between the pieces of page information.

The paging button 145 allows to display the preview PV of the first page for which the print setting is same as that for the last page for which the print setting is different from that for the page of the currently-displayed preview PV among the series of pages prior to the currently-displayed preview PV, between the last page and the first page there being no page for which the print setting is different from that for the last page.

The paging button 146 allows to display the preview PV of the last page for which the print setting is different from that for the page of the currently-displayed preview PV among the series of pages prior to the page of the currently-displayed preview PV.

The paging button 147 allows to display the preview PV of the previous page of the first page for which the print setting is different from that for the page of the currently-displayed preview among the series of pages after the page of the currently-displayed preview PV.

The paging button 148 allows the preview PV of the first page for which the print setting is different from that for the page of the currently-displayed preview among the series of pages after the page of the currently-displayed preview PV.

FIG. 9 is an explanatory diagram of an example showing a page transition rule by paging buttons 145-148.

With regard to FIG. 9 and an explanation using FIG. 9, an example where the print data of the print job input to the MFP 1 includes a total of 12 pages P1 to P12 and the currently-displayed preview PV is the preview of page P8 will be described. In FIG. 9, pages P1-P3 and P7-P9 have a print setting A, and pages P4-P6 and P10-P12 have a print setting B different from the print setting A.

When the paging button 145 receives the input instruction, the control section 6 performs to allow the preview PV of page P4 to be displayed within the preview frame 131 (P145 of FIG. 9).

When the paging button 146 receives the input instruction, the control section 6 performs to allow the preview PV of page P6 to be displayed within the preview frame 131 (P146 of FIG. 9).

When the paging button 147 receives the input instruction, the control section 6 performs to allow the preview PV of page P9 to be displayed within the preview frame 131 (P147 of FIG. 9).

When the paging button 148 receives the input instruction, the control section 6 performs to allow the preview PV of page P10 to be displayed within the preview frame 131 (P148 of FIG. 9).

The check buttons 151-153 set flags with respect to one or a plurality of pages included in the data based on the preview PV displayed within the preview frame 131 of the print setting confirmation screen 130. For the page to which the flag is set, the trial print management flag of the corresponding page information is allowed to be “already-checked”.

When any of the check buttons 151-153 receives the input instruction, similarly to the case that any of the check buttons 145-148 receives the input operation, the control section 6 detects the number of the page information which has a difference with respect to the page information of the page of the currently-displayed preview PV, and determines the page to which the flag is set based on the detected page number.

The check button 151 sets flags to pages from the last page for which the print setting is different from that for the page of the currently-displayed preview PV to the first page for which the print setting is same as that for the last page among the series of pages prior to the page of the currently-displayed preview PV. At that time, there is no page for which the print setting is different from that for the last page between the last page and the first page to which the flags are set respectively.

The check button 152 sets a flag to the page of the currently-displayed preview PV.

The check button 153 sets flags to pages, from the next page of the last page for which the print setting is different from that for the page of the currently-displayed preview PV among the series of pages prior to the page of the currently-displayed preview PV, to the previous page of the first page for which the print setting is different from that for the page of the currently-displayed preview PV among the series of pages after the page of the currently-displayed preview PV.

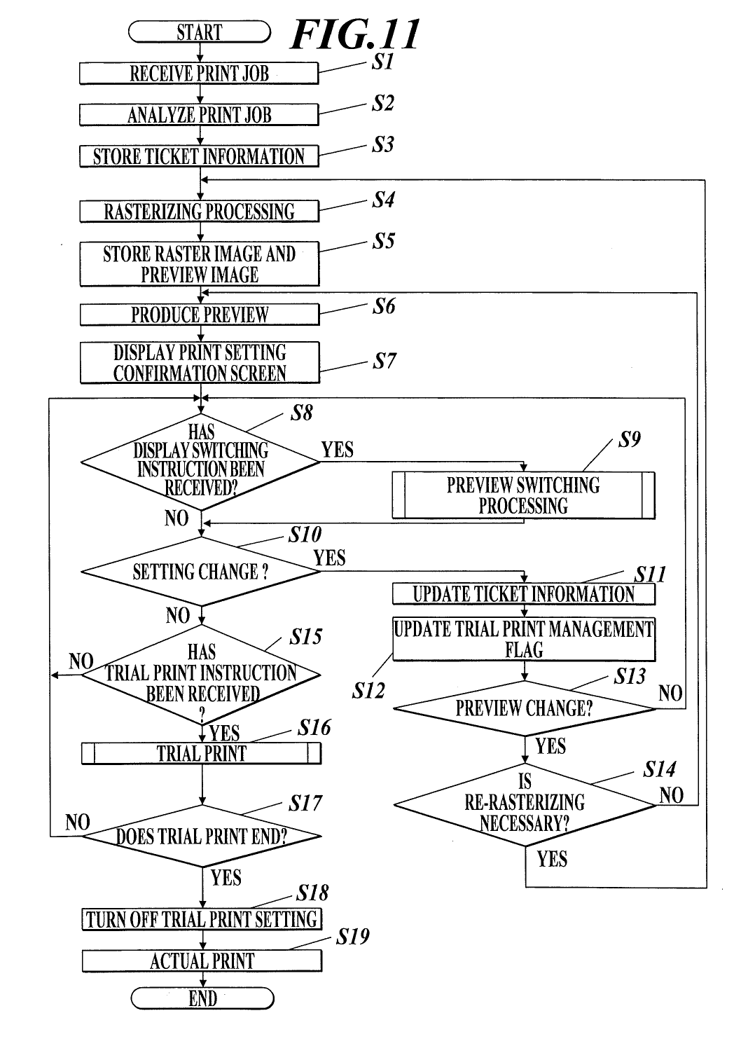

FIG. 10 is an explanatory diagram of an example showing a rule of setting flag by check buttons 151-153. With regard to FIG. 10 and an explanation using FIG. 10, an example where the print data of the print job input to the MFP 1 includes a total of 12 pages P1 to P12 and the currently-displayed preview PV is the preview of page P8 will be described. In FIG. 10, pages P1-P3 and P7-P9 have the print setting A, and pages P4-P6 and P10-P12 have the print setting B different from the print setting A. When the check button 151 receives the input instruction, the control section 6 performs processing to set the flags to pages P4-P6 respectively (F151 of FIG. 10).

When the check button 152 receives the input instruction, the control section 6 performs processing to set the flag to page P8 (F152 of FIG. 10).

When the check button 153 receives the input instruction, the control section 6 performs processing to set the flags to pages P7-P9 respectively (F153 of FIG. 10).

By performing input instruction to further set the flag to the page to which the flag has been already set, the flag can be cleared. With respect to the page from which the flag has been cleared, the trial print management flag of the corresponding page information is allowed to be “unchecked”.

The trial print buttons 161-163 perform an input instruction for the trial print. The trial print of this example is mainly used for correlating the print setting with the printing result, but it may be used for other purposes.

When the trial print button 161 or the trial print button 163 receives the input instruction, the control section 6 determines the page for which the trial print is performed based on a content of the trial print management flag in the page information of each page.

The trial print button 161 performs the trial print of the page for which the parameter regarding presence or absence of the flag in the trial print management flag is “already-checked” and the parameter regarding accomplishment or attempt of printing is “unprinted”.

The trial print button 162 performs the trial print of the page of the currently-displayed preview PV.

The trial print button 163 performs the trial print of all of the pages for which the parameters regarding presence or absence of the flag in the trial print management flag are “already-checked”. The trial print by the trial print button 163 is performed regardless the parameter regarding accomplishment or attempt of printing in the trial print management flag.

The control section 6 performs processing to allow the parameter regarding accomplishment or attempt of printing in the trial print management flag to be “already-printed” with respect to the page information of the page for which the trial print has been performed.

In the embodiment, a user can select whether or not the trial print ends after the trial print. The input instruction to end the trial print can be performed through the display operation section 7, and when the display operation section 7 receives the input instruction to end the trial print, the control section 6 performs an actual print. The actual print means to print all pages of the print data, and only sets of pages corresponding to the parameter regarding “the number of sets” of the job information. At that time, with respect to a page for which the trial print is performed one or more times, the number of times of the trial print may be subtracted from the number of time of the actual print. It is also possible to allow the actual print to be performed without performing the trial print.

In a job setting frame 132 of the print setting confirmation screen 130, a part of or all of pieces of the job information of the ticket information corresponding to the currently-displayed preview PV are displayed.

In a page setting frame 133 of the print setting confirmation screen 130, a part of or all of the pieces of page information corresponding to the page of the currently-displayed preview PV are displayed.

By the input instruction to the display operation section 7, parameters of items within the job setting frame 132 and items within the page setting frame 133 which are displayed in the print setting confirmation screen 130, or parameters of both of the items can be changed. The changed parameters are reflected in the job information and the page information respectively to be overwrite-stored in the storage section 4.

As that time, the parameter of the item which has been changed through the display operation section 7 is displayed so as to be visually distinguishable from parameters of other items which have not been changed. For example, as shown in FIG. 7, a parameter indicated by a reference sign “Z” is displayed with a bolder type font (bold specified text and the like) than a display font for other parameters.

When a change of the print setting, namely a change of the ticket information occurs, the control section 6 performs processing to allow the parameters regarding presence or absence of the flag to be “unchecked” based on changed contents of pieces of the ticket information with respect to a part of or all of pieces of the ticket information for which the parameters regarding presence or absence of the flag in the trial print management flag are “already-checked”.

When the page information has been changed, the control section 6 allows the parameter regarding presence or absence of the flag of the page information for which the parameter regarding presence or absence of the flag in the trial print management flag is “already-checked” among pieces of the changed page information to be “unchecked”.

When the job information has been changed, the control section 6 performs processing to allow the parameters regarding presence or absence of the flag of the page information for which the parameters regarding presence or absence of the flag in the trial print management flag are “already-checked” to be “unchecked” with respect to all the pieces of page information included in the ticket information containing the job information.

Next, an operation of the MFP 1 will be described with reference to flowcharts of FIGS. 11-22.

FIG. 11 is a flowchart showing a flow of processing of the MFP1 to which the print job has been transmitted.

When the print job is transmitted from the client PC 102 or the client PC 103, the MFP 1 receives the print job (Step S1). The control section 6 analyzes the received print job (Step S2) to store the ticket information in the storage section 4 (Step S3).

After that, the print controller 3 performs rasterizing processing based on the ticket information to create a raster image from the print data (Step S4). Then, the control section 6 creates the preview image from the raster image created in Step S4 to store it in the storage section 4 (Step S5). Incidentally, the step of storing the preview image in the storage section 4 in Step S5 is not imperative, and for example, storing the raster image in the RAM 62, and creating the reduced preview image from the stored raster image when displaying the preview is also possible. Then, the control section 6 produces the preview obtained by editing the preview image created in Step S5 based on the ticket information (Step S6).

After that, the control section 6 allows the display operation section 7 to display the print setting confirmation screen 130 (Step S7). The preview to be displayed in the print setting confirmation screen 130 in the processing of Step S7 is the preview created in Step S6. After the processing of Step S7, the control section 6 waits till the input instruction is received through the display operation section 7.

After that, when any of the paging buttons 141-148 receives the input instruction (display switching instruction) (Step S8: Yes), the control section 6 performs preview switching processing (Step S9).

When no display switching instruction is input (Step S8: No) and the input changing (setting changing) instruction with respect to the job setting or the page setting displayed in the print setting conformation screen 130 has been received (Step S10: Yes), the control section 6 updates the ticket information based on the changed setting contents (Step S11), and updates the trial print management flag (Step S12). The control section 6 also performs processing to allow the parameters regarding presence or absence of the flag to be “unchecked” with respect to a part of or all of the pieces of page information for which the parameters regarding presence or absence of the flag in the trial print management flag are “already-checked” based on the changed content of the ticket information.

After the processing of Step S12, the control section 6 judges whether or not the changed content of the ticket information of Step S11 is the content for changing the preview (Step S13). When the changed content of the ticket information is not the content for changing the preview (Step S13: No), the processing returns to the waiting state after Step S8.

Incidentally, the processing of changing the setting in the judgment in Step 10 and updating the ticket information in Step S11 include setting or deleting the flag by the input instruction to the check buttons 151-153.

On the other hand, when the changed content of the ticket information is the content for changing the preview (Step S13: Yes), the control section 6 judges whether or not the control section 6 needs re-rasterizing processing (Step S14).

When re-rasterizing processing is necessary (Step S14: Yes), the processing returns to Step S4. For example, when specification of Pure Black has been changed from “OFF” to “ON”, since it is necessary to change the raster image in which a black portion is color-reproduced by a combination of pigments of CMY to the raster image in which only pigment of K is used, the raster image needs to be created again. With recreation of the raster image, also the preview image is replaced.

On the other hand, when re-rasterizing processing is unnecessary (Step S14: No), the processing returns to Step S6. For example, when specification of a stapling position is changed from “left” to “right”, this change does not affect the reduced preview image, and this change just needs to allow a synthesizing position of an image indicating stapling to be change.

Whether or not the rasterizing processing is necessary in Step S14 is judged based on whether or not there has been the print setting change requiring the recreation of the raster image, which is not limited to the above example.

When neither the display switching instruction nor the setting change is received (Step 10: No) and when any of the trial print buttons 161-163 receives the input instruction (trial print instruction) (Step S15: Yes), the control section 6 allows the print section 7 to perform the trial print (Step S16). In Step S16, the control section 6 prints the page corresponding to the trial print button which has receives the input instruction.

After the processing of Step S16, the control section 6 judges whether or not the input instruction to end the trial print has been received (Step S17). When the input instruction to end the trial print has been received (Step S17: Yes), the control section 6 allows the trial print setting of the job information to be OFF (Step S18), performs the actual print (Step S19), and end the processing. When the input instruction to end the trial printing has not been received (Step S17: No), the processing returns to the waiting state after Step S7.

The judgment of the display switching instruction of Step S8, the judgment of the setting change of Step S10, and judgment of trial print instruction of Step S12 may be performed in random order, and the execution order is not particularly limited.

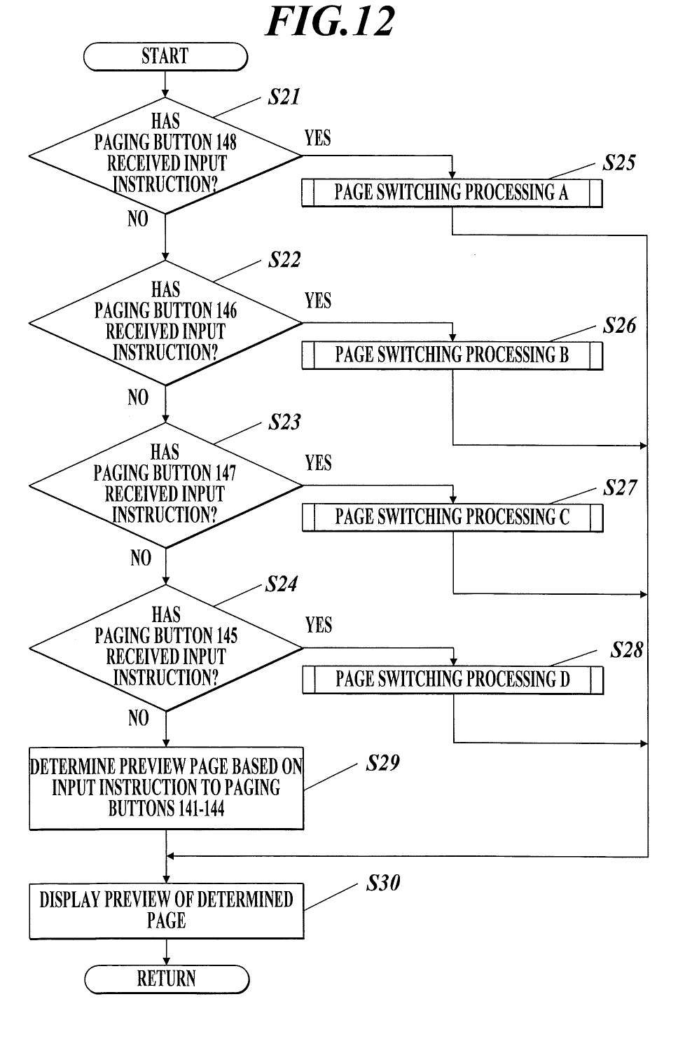

FIG. 12 is a flowchart showing a flow of the preview switching processing of Step S9 shown in FIG. 11.

The control section 6 judges which of the paging buttons 145-148 receives the input instruction (Steps 21-24). In the embodiment, the judgment is performed with regard to the paging button 148 (Step S21), paging button 146 (Step S22), paging button 147 (Step S23), and paging button 145 (Step Step S24), in that order, but Steps S21-24 may be performed in random order, and the execution order is not particularly limited.

When the paging button 148 has received the input instruction (Step S21: Yes), the control section 6 performs page switching processing A (Step S25).

When the paging button 148 has not received the input instruction (Step S21: No) and when the paging button 146 has received the input instruction (Step S22: Yes), the control section 6 performs page switching processing B (Step S26).

When the paging buttons 146, 148 have not received the input instruction (Step S22: No) and when the paging button 147 has received the input instruction (Step S23: Yes), the control section 6 performs page switching processing C (Step S27).

When the paging buttons 146-148 have not received the input instruction (Step S23: No) and when the paging button 145 has received the input instruction (Step S24: Yes), the control section 6 performs page switching processing D (Step S28).

When the paging buttons 145-148 have not received the input instruction (Step S24: No), the control section 6 judges whether or not the paging buttons 141-144 have received the input instruction, and determines the page for which the preview PV is displayed next depending on the paging button to which the input instruction has been input (Step S29).

After any of processings S25-S29, the control section 6 performs processing to allow the preview PV of the determined page within the preview frame 131 of the print setting confirmation screen 130 (Step S30), and ends the preview switching processing.

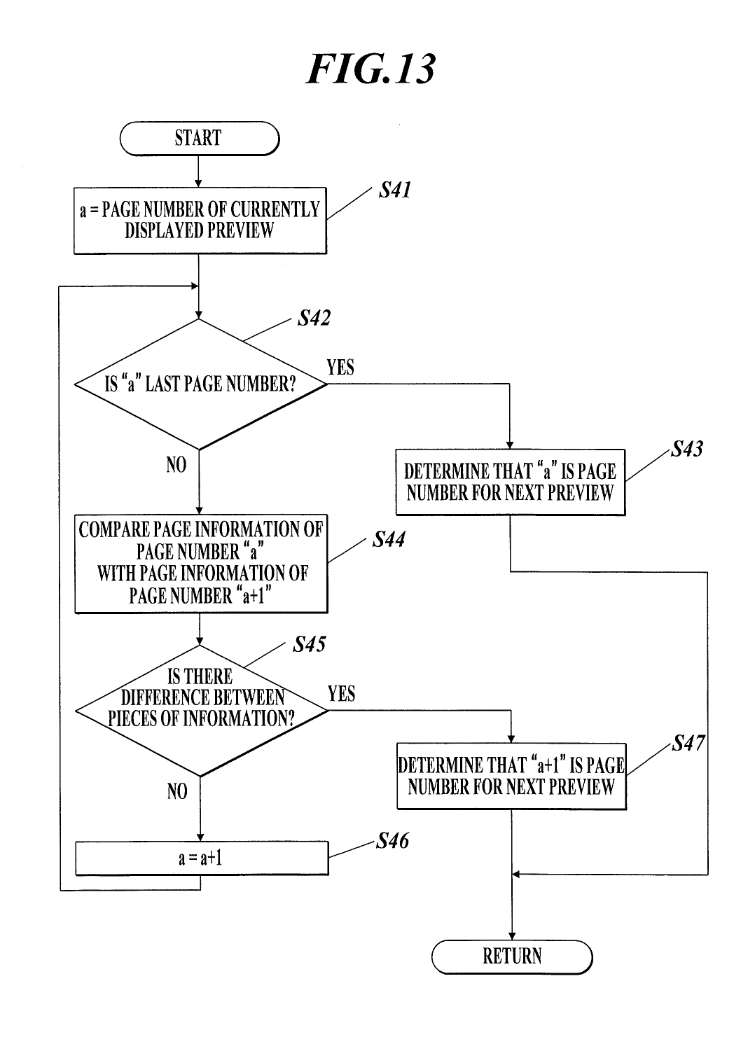

FIG. 13 is the flowchart showing a flow of the page switching processing A of Step S25 shown in FIG. 12.

The control section 6 declares a valuable “a” and allows the page number of the currently-displayed preview PV to be an initial value of “a” (Step S41). Next, the control section 6 judges whether or not “a” is a last page number of the print data (Step S42). When “a” is the last page number of the page data (Step S42: Yes), the control section 6 determines that “a” is the page number for displaying the preview PV next (Step S43), and ends the page switching processing A.

When “a” is not the last page number of the print data (Step S42: No), the control section 6 compares the information of page number “a” with the information of page number “a+1” (Step S44), and judges whether or not there is a difference between the information of page number “a” and the information of page number “a+1” (Step S45). When there is no difference between the information of page number “a” and the information of page number “a+1” (Step S45: No), the control section 6 increments one (1) to the value of “a” (Step S46), and returns to the processing of Step S42.

When there is a difference between the information of page number “a” and the information of page number “a+1” (Step S45: Yes), the control section 6 determines that “a+1” is the page number for displaying the preview PV next (Step S47), and ends the page switching processing A.

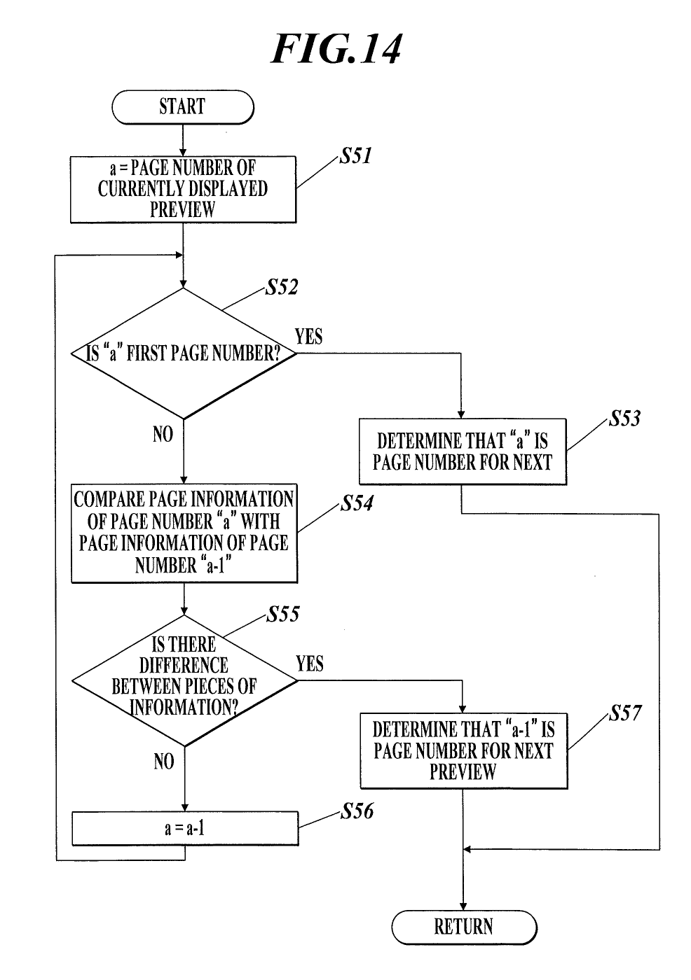

FIG. 14 is the flowchart showing a flow of the page switching processing B of Step S26 shown in FIG. 12.

The control section 6 declares a valuable “a” and allows the page number of the currently-displayed preview PV to be an initial value of “a” (Step S51). Next, the control section 6 judges whether or not “a” is a first page number of the print data (Step S52). When “a” is the first page number of the page data (Step S52: Yes), the control section 6 determines that “a” is the page number for displaying the preview PV next (Step S53), and ends the page switching processing B.

When “a” is not the first page number of the print data (Step S52: No), the control section 6 compares the information of page number “a” with the information of page number “a−1” (Step S54), and judges whether or not there is a difference between the information of page number “a” and the information of page number “a−1” (Step S55). When there is no difference between the information of page number “a” and the information of page number “a−1” (Step S55: No), the control section 6 decrements one (1) from the value of “a” (Step S56), and returns to the processing of Step S52.

When there is a difference between the information of page number “a” and the information of page number “a−1” (Step S55: Yes), the control section 6 determines that “a−1” is the page number for displaying the preview PV next (Step S57), and ends the page switching processing B.

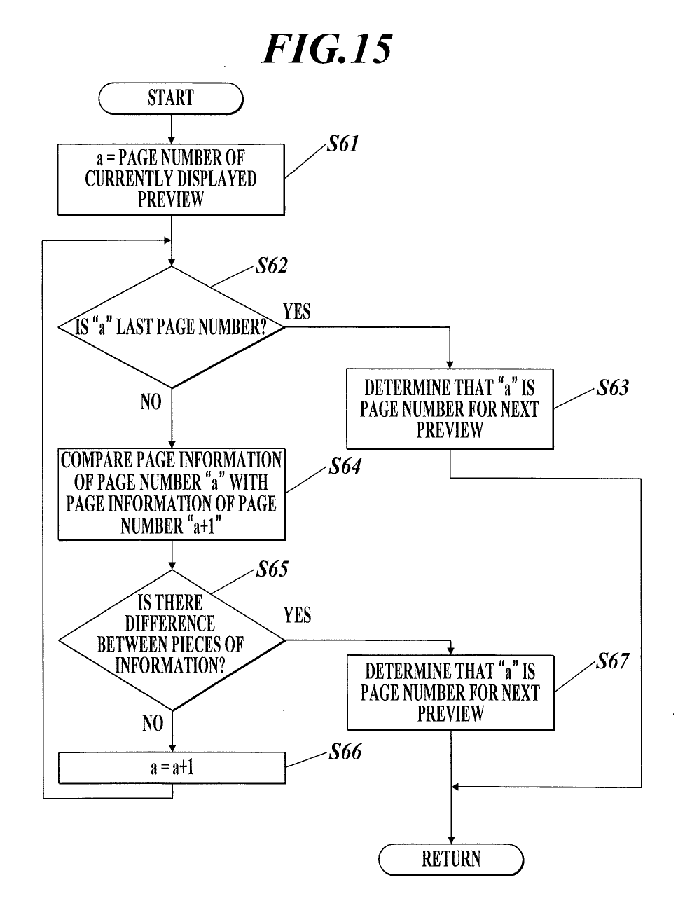

FIG. 15 is the flowchart showing a flow of the page switching processing C of Step S27 shown in FIG. 12. The control section 6 declares a valuable “a” and allows the page number of the currently-displayed preview PV to be an initial value of “a” (Step S61). Next, the control section 6 judges whether or not “a” is a last page number of the print data (Step S62). When “a” is the last page number of the page data (Step S62: Yes), the control section 6 determines that “a” is the page number for displaying the preview PV next (Step S63), and ends the page switching processing C.

When “a” is not the last page number of the print data (Step S62: No), the control section 6 compares the information of page number “a” with the information of page number “a+1” (Step S64), and judges whether or not there is a difference between the information of page number “a” and the information of page number “a+1” (Step S65). When there is no difference between the information of page number “a” and the information of page number “a+1” (Step S65: No), the control section 6 increments one (1) to the value of “a” (Step S66), and returns to the processing of Step S62.

When there is a difference between the information of page number “a” and the information of page number “a+1” (Step S65: Yes), the control section 6 determines that “a” is the page number for displaying the preview PV next (Step S67), and ends the page switching processing C.

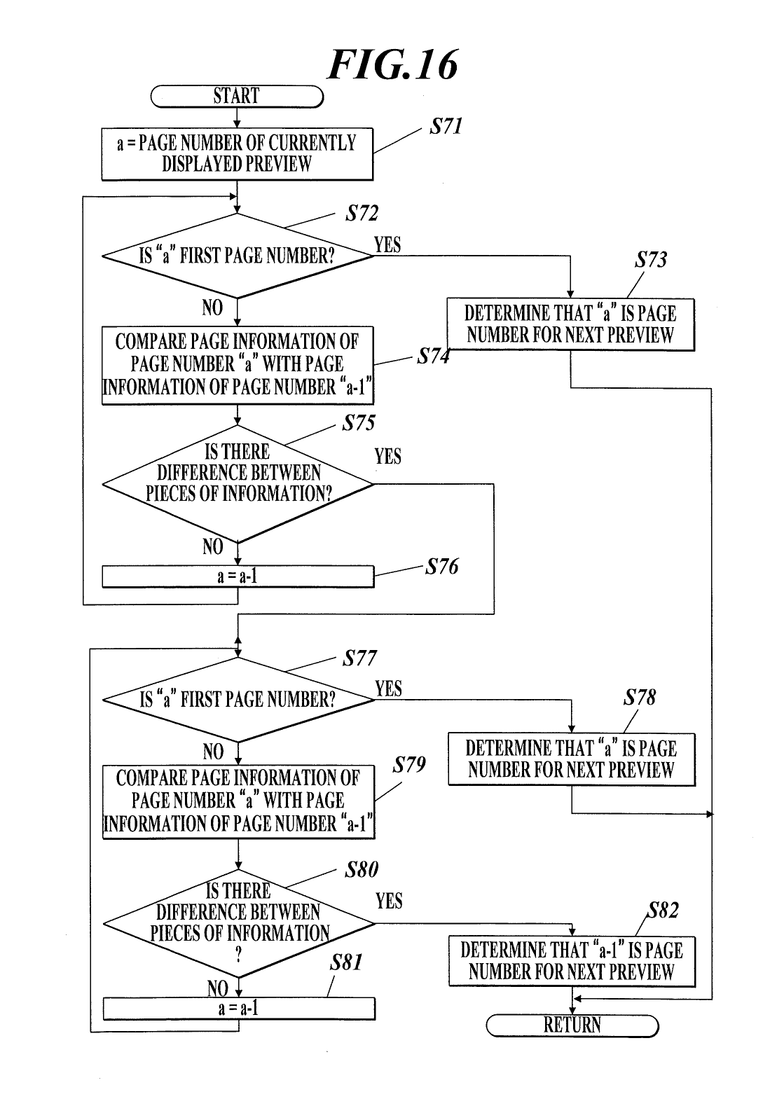

FIG. 16 is the flowchart showing a flow of the page switching processing D of Step S28 shown in FIG. 12.

The control section 6 declares a valuable “a” and allows the page number of the currently-displayed preview PV to be an initial value of “a” (Step S71). Next, the control section 6 judges whether or not “a” is a first page number of the print data (Step S72). In Step S72, when “a” is the first page number of the page data (Step S72: Yes), the control section 6 determines that “a” is the page number for displaying the preview PV next (Step S73), and ends the page switching processing D.

In Step S72, when “a” is not the first page number of the print data (Step S72: No), the control section 6 compares the information of page number “a” with the information of page number “a−1” (Step S74), and judges whether or not there is a difference between the information of page number “a” and the information of page number “a−1” (Step S75). In Step S75, when there is no difference between the information of page number “a” and the information of page number “a−1” (Step S75: No), the control section 6 decrements one (1) from the value of “a” (Step S76), and returns to the processing of Step S72.

In Step S75, when there is a difference between the information of page number “a” and the information of page number “a−1” (Step S75: Yes), the control section 6 judges whether or not “a” is the first page number of the print data (Step S77). In Step S77, when “a” is the first page number of the print data (Step S77: Yes), the control section 6 determines that “a” is the page number for displaying the preview PV next (Step S78), and ends the page switching processing D.

In Step S77, when “a” is not the first page number of the print data (Step S77: NO), the control section 6 compares the page information of page number “a” with the page information of page number “a−1” (Step S79) to judge whether or not there is a difference between the page information of page number “a” and the page information of page number “a−1” (Step S80). In Step S79, when there is no difference between the page information of page number “a” and the page information of page number “a−1” (Step S80: No), the control section 6 decrements one (1) from the value of “a” (Step S81), and returns to the processing of Step S77.

In Step S80, when there is a difference between the page information of page number “a” and the page information of page number “a−1” (Step S80: Yes), the control section 6 determines that “a” is the page number for displaying the preview PV next (Step S82), and ends the page switching processing D.

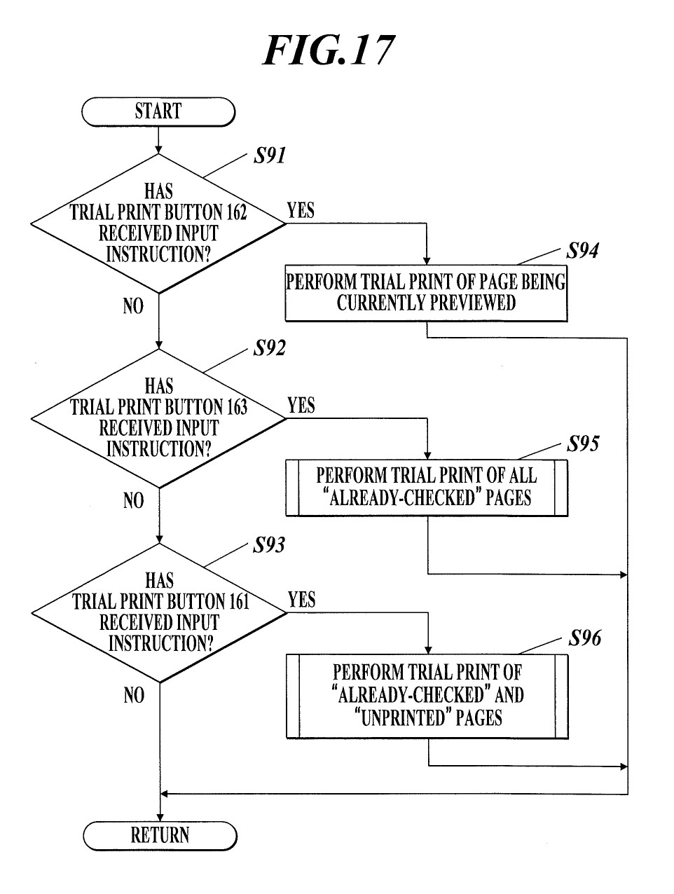

FIG. 17 is the flowchart showing a flow of the trial print processing of Step S16 shown in FIG. 11.

The control section 6 judges which of trial print buttons 161-163 has received the input instruction (Steps S91-93). In the embodiment, the judgment is performed with respect to the trial print button 162 (Step S91), trial print button 163 (Step S92), and trial print button 161 (Step S93), in that order, but Steps S91-S93 may be performed in random order, and the execution order is not especially limited.

When the trial print button 162 has received the input instruction (Step S91: Yes), the control section 6 allows the print section 7 to perform the trial print of the page of the currently-displayed preview PV (Step S94).

When the trial print button 162 has not received the input instruction (Step S91: No), and the trial print button 163 has received the input instruction (Step S92: Yes), the control section 6 allows the print section 7 to perform the trial print of all pages for which the parameters regarding presence or absence of the flag in the trial print management flag are “already-checked” (Step S95).

When the trial print buttons 162, 163 have not received the input instruction (Step S92: No), and when the trial print button 161 has received the input instruction (Step S93: Yes), the control section 6 allows the print section 7 to perform the trial print of the pages for which the parameters regarding presence or absence of the flag in the trial print management are “already-checked” and the parameters regarding accomplishment or attempt of printing in the trial print management flag are “unprinted” (Step S95).

After processing of Steps S94-S96, or when any of the trial print buttons 161-163 has not received the input instruction (Step S93: No), the control section 6 ends the trial print processing.

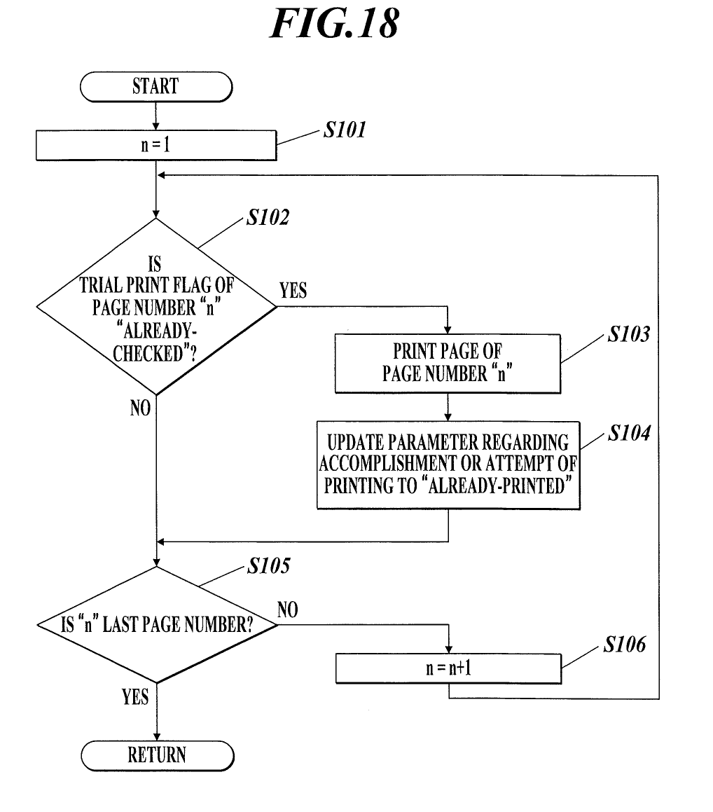

FIG. 18 is the flow chart showing a flow of the trial print processing of all “already-checked” pages of Step S95 shown in FIG. 17.

The control section 6 declares a valuable “n” an initial value one (1) (Step S101). Then, the control section 6 judges whether or not the parameter regarding presence or absence of the flag in the trial print management flag of the page information of page number “n” is “already-checked” (Step S102).

When the parameter regarding presence or absence of the flag in the trial print management flag is “already-checked” (Step S102: Yes), the control section 6 allows the print section 7 to print the page of page number “n” (Step S103), and allows the parameter regarding accomplishment or attempt of printing in the trial print management flag to be “already-printed” (Step S104).

After the processing of Step S104 or when the parameter regarding presence or absence of the flag in the trial print management is not “already-checked”, namely “unchecked” (Step S102), the control section 6 judges whether or not “n” is the last page number of the print data (Step S105). When “n” is not the last page number (Step S105: No), the control section 6 increments one (1) to “n” (Step S106), and returns the processing of the Step S102. When “n” is the last page number (Step S105: Yes), the control section 6 ends the trial print processing of all “already-checked” pages.

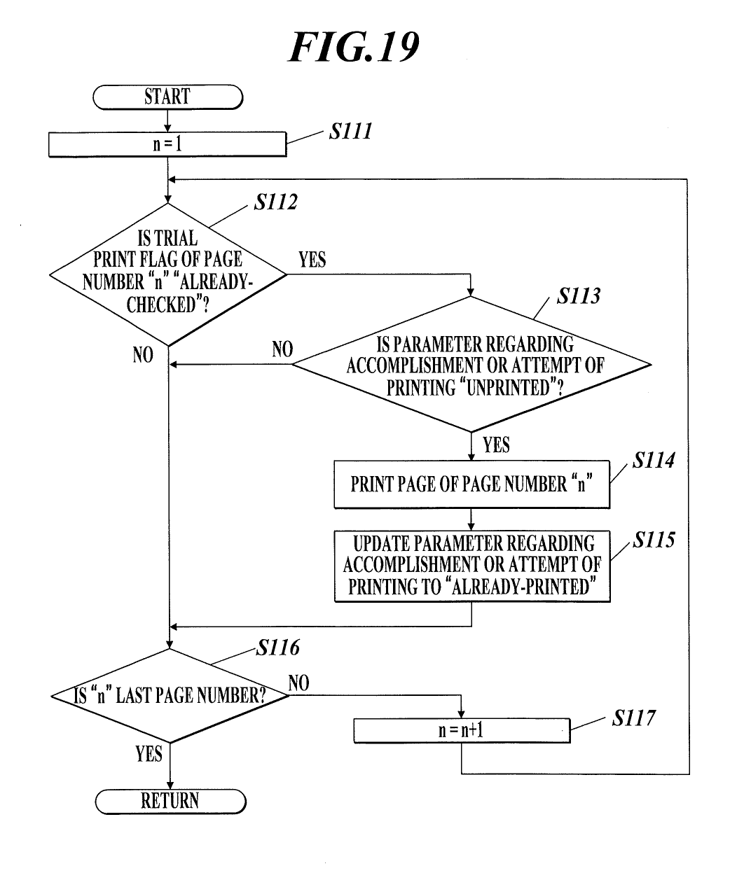

FIG. 19 is the flowchart showing a flow of trial print processing of the “already-checked” and “unprinted” pages of Step S96 shown in FIG. 17.

The control section 6 declares a valuable “n” an initial value one (1) (Step S111). Then, the control section 6 judges whether or not the parameter regarding presence or absence of the flag in the trial print management flag of the page information of page number “n” is “already-checked” (Step S112).

When the parameter regarding presence or absence of the flag in the trial print management flag is “already-checked” (Step S112: Yes), the control section 6 judges whether or not the parameter regarding accomplishment or attempt of printing in the trial print management flag of the page information of page number “n” is “unprinted” (Step S113). When the parameter regarding accomplishment or attempt of printing in the trial print management flag is “unprinted” (Step S113: Yes), the control section 6 allows the print section 7 to print the page of page number “n” (Step S114), and allows the parameter regarding accomplishment or attempt of printing in the trial print management flag to be “printed” (Step S115).

After the processing of Step S115, when the parameter regarding presence or absence of the flag in the trial print management flag is not “already-checked”, namely “unchecked” (Step S112: No), or when the parameter regarding accomplishment or attempt of printing in the trial print management flag is not “unprinted”, namely “already-printed” (Step S113: No), the control section 6 judges whether or not “n” is the last page number of the print data (Step S116). When “n” is not the last page number of the print data (Step S116: No), the control section 6 increments one (1) to “n” (Step S117), and returns to the processing of Step S112. When “n” is the last page number of the print data (Step S116: Yes), the control section 6 ends the trial print processing of the “already-checked” and “unprinted” pages.

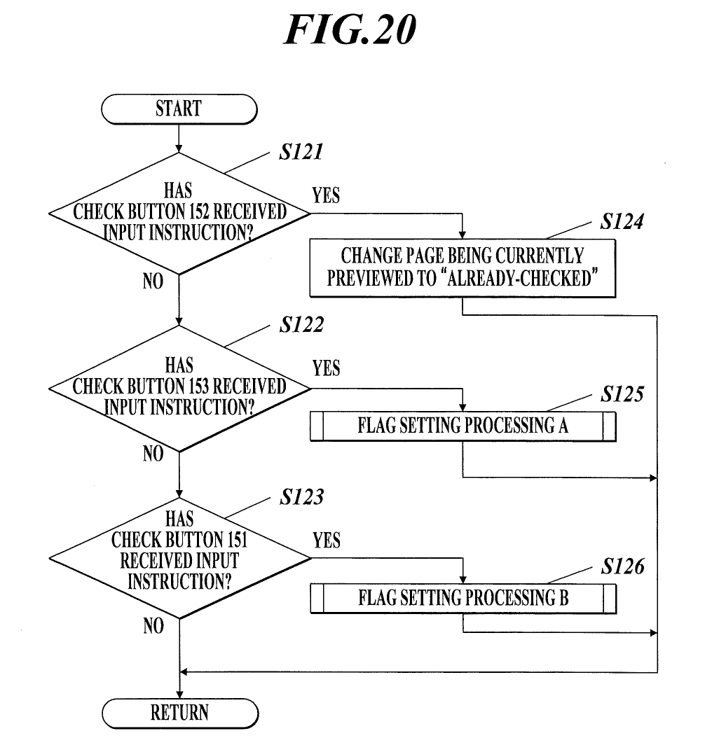

FIG. 20 is the flowchart showing a flow of processing when any of the check buttons 151-153 has received the input instruction.

The control section 6 judges which of the check buttons 151-153 has received the input instruction (Steps S121-S123). In the embodiment, the judgment is performed with respect to the check button 152 (Step S112), check button 153 (Step S122), and check button 151 (Step S123), in that order, but Steps S121-S123 may be performed in random order, and the execution order is not particularly limited.

When the check button 152 has received the input instruction (Step S121: Yes), the control section 6 performs processing to allow the parameter regarding presence or absence of the flag in the trial print management flag to be “already-checked” with respect to the page information of the page of the currently-displayed preview PV (Step S124).

When the check button 153 has received the input instruction (Step S122: Yes), the control section 6 performs the flag setting processing A to allow the parameters regarding presence or absence of the flag in the trial print management flag to be “already-checked” with respect to the pages from the next page of the last page for which the print setting is different from that for the pages of the currently-displayed preview PV among the series of pages prior to the page of the currently-displayed preview PV to the previous page of the first page for which the print setting is different from that for the page of the currently-displayed preview PV among the series of pages after the page of the currently-displayed preview PV (Step S125).

When the check button 151 has received the input instruction (Step S123: Yes), the control section 6 performs the flag setting processing B to allow the parameters regarding presence or absence of the flag in the trial print management flag to be “already-checked” with respect to the pieces of page information of pages from the last page for which the print setting is different from the page of the currently-displayed preview PV to the first page for which the print setting is same as the last page among the series of pages prior to the page of the currently-displayed preview PV (Step S126).

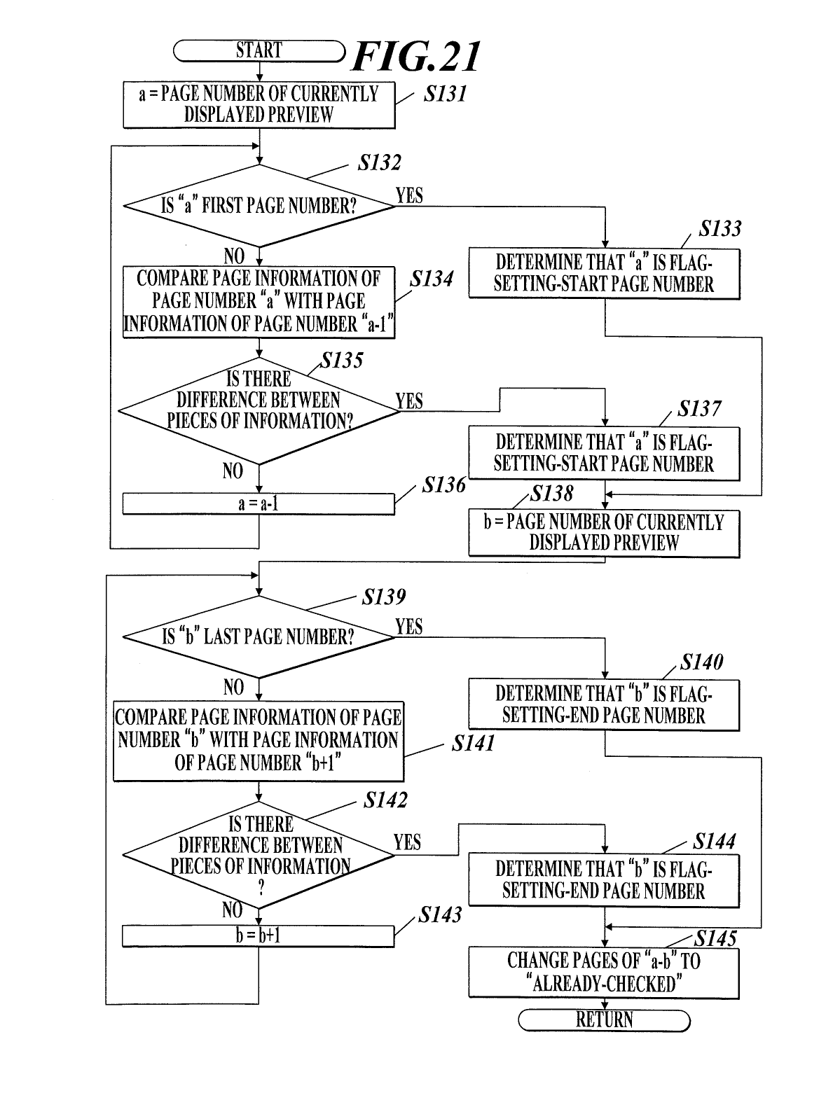

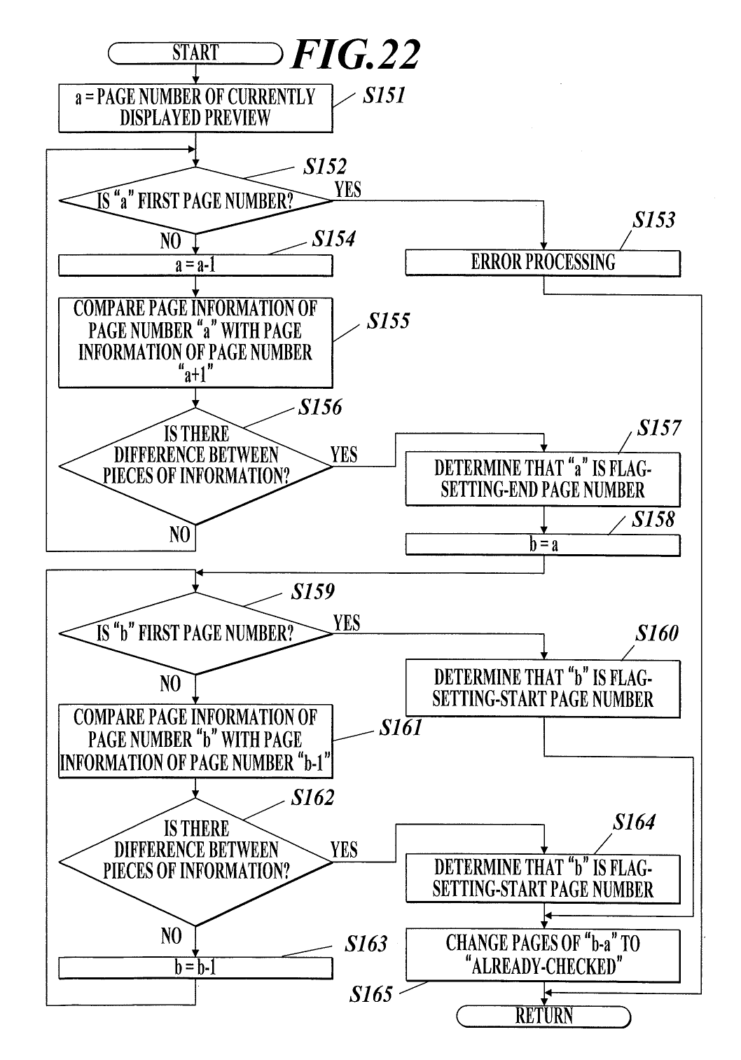

FIG. 21 is the flowchart showing a flow of the flag setting processing A of Step S125 of FIG. 20. The control section 6 declares a valuable “a”, and allows the page number of the currently-displayed preview PV to be an initial value of “a” (Step S131). Then, the control section 6 judges whether or not “a” is the first page number of the print data (Step S132: Yes). When “a” is the first page number of the print data (Step S133), the control section 6 determines that “a” is the flag-setting-start page number (Step S133).

When “a” is not the first page number of the print data (Step S132: No), the control section 6 compares the page information of page number “a” with the page information of page number “a−1” (Step S134), and judges whether or not there is a difference between the page information of page number “a” and the page information of page number “a−1” (Step S135). When there is no difference between the page information of page number “a” and the page information of page number “a−1” (Step S135: No), the control section 6 decrements one (1) from the value of “a” (Step S136), and returns to the processing of Step S132.

When there is a difference between the page information of page number “a” and the page information of page number “a−1” (Step S135: Yes), the control section 6 determines that “a” is the flag-setting-start page number (Step S137).

After the processing of Step S133 or Step S137, the control section 6 declares a valuable “b”, and allows the page number of the currently-displayed preview PV to be the initial value of “b” (Step S138). Then, the control section 6 judges whether or not “b” is the last page number of the print data (Step S139). When “b” is the last page number of the print data (Step S139: Yes), the control section 6 determines that “b” is a flag-setting-end page number (Step S140).

When “b” is not the last page number of the print data (Step S139: No), the control section 6 compares the page information of page number “b” with the page information of page number “b+1” (Step S141), and judges whether or not there is a difference between the page information of page number “b” and the page information of page number “b+1” (Step S142). When there is no difference between the page information of page number “b” and the page information of page number “b+1” (Step S142: No), the control section 6 increments one (1) to the value of “b” (Step S143), and returns to the processing of Step S139.

When there is a difference between the page information of page number “b” and the page information of page number “b+1” (Step S142: Yes), the control section 6 determines that “b” is the flag-setting-end page number (Step S144).

After processing of Step S140 or Step S144, the control section 6 performs processing to the parameters regarding presence or absence of the flag in the trial print management flag to be “already-checked” with respect to the pieces of page information respectively having the page numbers a-b (Step S145), and ends the flag setting processing A.

FIG. 22 is the flowchart showing a flow of the flag setting processing B of Step S126 of FIG. 20.

The control section 6 declares a valuable “a”, and allows the page number of the currently-displayed preview PV to be the initial value of “a” (Step S151). Then, the control section 6 judges whether or not “a” is the first page number of the print data (Step S152). When “a” is the first print number of the print data (Step S152: Yes), the control section 6 performs the error processing (Step S153), and ends the processing of Step S126 shown in FIG. 20. The error processing is a processing to inform that there is no page which meets an input instruction condition.

When “a” is not the first page number of the print data (Step S152: NO), the control section 6 decrements one (1) from the value of “a” (Step S154), and compares the page information of page number “a” with the page information of page number “a+1” (Step S155), and judges whether or not there is a difference between the page information of page number “a” and the page information of page number “a+1” (Step S156). When there is no difference between the page information of page number “a” and the page information of page number “a+1” (Step S156: NO), the control section 6 returns to the processing of Step S152.

When there is a difference between the page information of page number “a” and the page information of page number “a+1” (Step S156: Yes), the control section 6 determines that “a” is the flag-setting-end page number (Step S157).

After the processing of Step S157, the control section 6 declares a valuable “b”, and allows “a” to be the initial value (Step S158). Then, the control section 6 judges whether or not “b” is the first page number of the print data (Step S159). When “b” is the first page number of the print data (Step S159: Yes), the control section 6 that “b” is the flag setting start number (Step S160).

When “b” is not the first page number of the print data (Step S159: No), the control section 6 compares the page information of page number “b” with the page information of page number “b−1” (Step S161), and judges whether or not there is a difference between the page information of page number “b” and the page information of page number “b−1” (Step S162). When there is no difference between the page information of page number “b” and the page information of page number “b−1” (Step S162: No), the control section 6 decrements one (1) from the value of “b” (Step S163), and returns to the processing of Step S159.

When there is a difference between the page information of page number “b” and the page information of page number “b−1” (Step S162: Yes), the control section 6 determines that “b” is the flag-setting-end page number (Step S164).

After the processing of Step S160 or Step S164, the control section 6 performs processing to allow the parameters regarding presence or absence of the flag in the trial print management flag to be “already-checked” with respect to the pieces of page information respectively having page numbers a-b (Step S165), and ends the flag setting processing B.

When the parameter in the trial print management flag is changed by the processings shown in FIGS. 20-22, it is judged that the setting has been changed in the determining processing of setting changes in Step S10 shown in FIG. 11.

Incidentally, it is a matter of course that the embodiment of the present invention disclosed herewith is merely an example and does not limit the present invention in all respects. The scope of the present invention is not shown by the above explanation, but shown by the claims, and it is intended that the present invention includes all changes within the scope of the claims and its equivalents.

In the abovementioned embodiment, the control of the preview PV and the controls of flag setting and the trial print are performed by the input instruction with the display operation section 7 of the MFP 1 and the processing by the control section 6, but the controls may be performed by a configuration other than that of the MFP 1. For example, the controls may be performed by external equipment including an input device and a display device.

As the abovementioned embodiment, the page information may include the setting information pertaining to finishing as the item of the print setting. Alternatively, it is also possible to allow the item regarding to finishing not to be contained in the print setting.

When all pages included in the print data have common page information, the function to determine the page for next preview and the page for flag setting based on presence or absence of a difference among print settings of the pages need not to be used. In this case, the control section previously compares the pieces of page information of all pages to detect that there is no difference among the pieces of page information of all pages. When the parameter of the page information is changed after the fact, it is possible to use the function to determine the page for next preview and the page for flag setting based on presence or absence of the difference among the print settings of the pages at the time when the change occurs.

Each parameter may be other values discernible by the control section. For example, the trial flag may have any parameter values as long as whether the flag is ON or OFF can be discerned by the parameter values. For example, a configuration where the parameter of the trial flag has a value of zero (0) or one (1) and one value is regarded as ON and the other is regarded as OFF may be adopted. It is also possible to perform similar operation by using other parameter values. The same can be said for other parameters.

In the setting change, the print settings of a plurality of pages having same print setting may be changed at a time. An example thereof will be described.

Firstly, a check box indicating “collectively change a page print setting by the same setting as that of preview-displayed page” is provided in the print setting confirmation screen. Then, when the setting of the preview-displayed page is changed while the check box is checked, the print settings of other pages are changed in a lump by the same setting as that of the preview displayed page.

For collectively changing the print setting of a plurality of pages which have same print setting, a method is not limited to the above, and other method may be used. For example, the print setting of the page for which the parameter regarding presence or absence of the flag in the trial print management flag is “already-checked”, for which pages and other pages the setting is same as that for the preview-displayed pages, may be correctively changed. Objects of collective change of the print setting may be changed depending on various parameters, condition, and so on.

In the above description, an example in which the ROM is used as the computer readable medium for the program of the present invention is shown, but the present invention is not limited to the example. As other computer readable medium, a nonvolatile memory such as flash memory, a portable recording medium such as CD-ROM may be applied. As a medium for providing the data of the program of the present invention through a communication line, also a carrier wave may be applied to the present invention.

According to one aspect of the preferred embodiment of the present invention, there is provided an image processing apparatus to preview an image to be printed, the image processing apparatus including: an input section to receive an instruction to preview a next image; and a control section to specify an image to be previewed next based on the instruction input through the input section, wherein the control section detects a page for which a print setting content is different from a print setting content for the page of a currently-previewed image among a plurality of pages included in print data to determine the image to be previewed next according to a detected result.

According to the embodiment, based on the input through the display operation section 7, the control section 6 detects the page for which the print setting is different from that for the page of the currently-displayed preview PV, and determines the page for displaying the preview PV next based on the detected page number. By this, a difference among the print settings of a plurality of pages may be detected, and the turn of the print setting can be confirmed by the preview. Thus, by performing the preview for each print setting so as to perform print instruction with respect to the previewed page, a confirmation operation such as confirming the printing result of each print setting can be performed smoothly. As described above, the MFP 1 of the embodiment can pick up the page for which the print setting is expected to be wrongly set when printing is performed based on the print data including a plurality of pages.

According to one aspect of the preferred embodiment of the present invention, the control section determines as the image to be previewed next an image of a first page for which the print setting content is different from the print setting content for the page of the currently-previewed image among a series of pages after the page of the currently-previewed image.

By the input instruction to the paging button 148, the control section 6 allows to display the preview PV of the first page for which the print setting is different from that for the page of the currently-displayed preview PV among the series of pages after the page of the currently-displayed preview PV. By this, it becomes possible to confirm the preview PV of the first page for which the print setting is different from that for the page of the currently-displayed preview PV, and by confirming the preview for each print setting and performing the print instruction to the previewed page, a confirmation operation such as confirming the printing result for each print setting can be performed smoothly.

According to one aspect of the preferred embodiment of the present invention, the control section determines as the image to be previewed next an image of a previous page of the first page for which the print setting content is different from the print setting content for the page of the currently-previewed image among a series of pages after the page of the currently-previewed image.

By the input instruction to the paging button 147, the control section 6 allows to display the preview PV of the previous page of the first page for which the print setting is different from that for the page of the currently-displayed preview PV among the series of pages after the page of the currently-displayed preview PV. By this, it becomes possible to confirm the turn of the print setting of the series of pages after the page of the currently-displayed preview PV.

According to one aspect of the preferred embodiment of the present invention, the control section determines as the image to be previewed next an image of a last page for which the print setting content is different from the print setting content for the page of the currently-previewed image among a series of pages prior to the page of the currently-previewed image.

By the input instruction to the paging button 146, the control section 6 allows to display the preview PV of the last page for which the print setting is different from that for the page of the currently-displayed preview PV among the series of pages prior to the page of the currently-displayed preview PV. By this, it becomes possible to confirm the turn of the print setting of the series of pages prior to the page of the currently-displayed preview PV by the preview.

According to one aspect of the preferred embodiment of the present invention, the control section determines as the image to be previewed next an image of a first page for which the print setting content is same as the print setting content for a last page for which the print setting content is different from the print setting content for the page of the currently-previewed image among a series of pages prior to the page of the currently-previewed image, there being no page for which the print setting content is different from the print setting content for the last page between the last page and the first page.

By the input instruction to the paging button 145, the control section 6 allows to display the preview PV of the first page which has the print setting same as that of the last page for which the print setting is different from that for the page of the currently-displayed preview PV among the series of pages prior to the page of the currently-displayed preview PV, between the last page and the first page there being no page for which the print setting is different from that for the last page. By this, it becomes possible to confirm the turn of the print setting among the series of pages prior to the pages at the time of input operation to the paging button 146, while using the page of the currently-displayed preview PV as a reference page.

According to one aspect of the preferred embodiment of the present invention, the input section enables an input of an instruction to set a flag or to delete an already-set flag to one or a plurality of pages included in the print data based on the page of the currently-previewed image, and the control section performs print processing of the image of the page included in the print data based on the flag.

It is also possible to input the instructions to set the flag or delete the already-set flag to/from the pieces of page information of one or a plurality of pages included in the print data based on the page of the currently-displayed preview PV, and the control section 6 performs the trial print based on the flag of each of the pieces of page information. By this, the page for which the trial print is performed is determined based on the page of the currently-displayed preview PV, and a user can confirm the printing result of the trial print so as to set the flag to an arbitrary page to confirm whether or not a desired printing result is obtained with respect to the page to which the flag has been set.

According to one aspect of the preferred embodiment of the present invention, the flag is set to the page of the currently-previewed image.

By the input instruction to the check button 152, the control section 6 sets the flag to the page of the currently-displayed preview PV. By this, it becomes possible to flexibly set the flag, and an operation such as selecting only the first page having a different setting to perform the trial print thereof becomes possible.

According to one aspect of the preferred embodiment of the present invention, the flag is set to each of pages from a next page of a last page for which the print setting content is different from the print setting content for the page of the currently-previewed image among a series of pages prior to the page of the currently-previewed image to a previous page of a first page for which the print setting content is different from the print setting content for the page of the currently-previewed image among a series of pages after the page of the currently-previewed image. By the input instruction to the check button 153, the control section 6 sets the flag to the pages from the next page of the last page for which the print setting is different from that for the page of the currently-displayed preview PV among the series of pages prior to the page of the currently-displayed preview PV to the previous page of the first page for which the print setting is different from that for the page of the currently-displayed preview PV. By this, it becomes possible to perform the flag setting and the trial print with respect to one or a plurality other pages for which the print setting is same as that for the page of the currently-displayed preview PV, between the page of the currently-displayed preview PV and any of the other pages there being no page for which the print setting is different. In other words, the control of the flag setting and the control of object of the trial print can be performed based on the page of the currently-displayed preview PV.

According to one aspect of the preferred embodiment of the present invention, the flag is set to each of pages from a last page for which the print setting content is different from the print setting content for the page of the currently-previewed image to a first page for which the print setting content is same as the print setting content for the last page among a series of pages prior to the page of the currently-previewed image.

By the input instruction to the paging button 151, the control section 6 sets the flag to the pages from the last page for which the print setting is different from that for the page of the currently-displayed preview PV to the first page for which the print setting is same as the last page among the series of pages prior to the page of the currently-displayed preview PV. By this, it becomes possible to perform the trial print of one or a plurality of pages for which the print setting is different from that for the page of the currently-displayed preview PV among the series of pages prior to the page of the currently-displayed preview PV, among the one or a plurality of pages there being no page for which the print setting is different from the different print setting. In other words, it becomes possible to perform the control of the flag setting and the control of object of the trial print based on the page of the currently-displayed preview PV or newer pages than it among the series of page prior to the currently-displayed preview PV, for which page or newer pages the print setting is different from that for the page of the currently-displayed preview PV, based on the page of the currently-displayed preview PV.

According to one aspect of the preferred embodiment of the present invention, there is no page for which the print setting content is different from the print setting content for the last page between the last page for which the print setting content is different from the print setting content for the page of the currently-previewed image and the first page for which the print setting content is same as the print setting content for the last page among the series of pages prior to the page of the currently-previewed image. In flag setting by the control section 6 by the input instruction to the check button 151, there is no page for which the print setting is different from that for the last page between the last page and the first page to which the flags are set respectively. By this, even when two or more different kinds of print settings are set to the series of pages prior to the page of the currently-displayed preview PV, the control regarding presence or absence of flag setting can be performed, while using the turn of the print setting as a reference, without getting the two or more different kinds of print settings confused.

According to one aspect of the preferred embodiment of the present invention, the input section enables at least an input of an instruction to change the print setting content for the page of the currently-previewed image, and the control section allows a display device to perform a display in which a changed portion of the print setting content is visually distinguishable from an unchanged portion of the print setting content.

It is also possible to input instructions to change the page setting of the page of the currently-displayed preview PV, the job setting of the print job including the page of the currently-displayed preview PV, and both of them, through the display operation section 7. The control section 6 allows to display the changed parameter so as to be visually distinguishable from the unchanged parameter. By this, a user can easily change the print setting, and can clearly confirm the changed portion.

What is claimed is:

1. An image processing apparatus to preview an image to be printed, the image processing apparatus comprising:
an input section to receive an instruction to preview a next image; and
a control section to specify an image to be previewed next based on the instruction input through the input section,
wherein the control section detects a page for which a print setting content is different from a print setting content for the page of a currently-previewed image among a plurality of pages included in print data to determine the image to be previewed next according to a detected result.

2. The image processing apparatus of claim 1, wherein the control section determines as the image to be previewed next an image of a first page for which the print setting content is different from the print setting content for the page of the currently-previewed image among a series of pages after the page of the currently-previewed image.

3. The image processing apparatus of claim 1, wherein the control section determines as the image to be previewed next an image of a previous page of the first page for which the print setting content is different from the print setting content for the page of the currently-previewed image among a series of pages after the page of the currently-previewed image.

4. The image processing apparatus of claim 1, wherein the control section determines as the image to be previewed next an image of a last page for which the print setting content is different from the print setting content for the page of the currently-previewed image among a series of pages prior to the page of the currently-previewed image.

5. The image processing apparatus of claim 1, wherein the control section determines as the image to be previewed next an image of a first page for which the print setting content is same as the print setting content for a last page for which the print setting content is different from the print setting content for the page of the currently-previewed image among a series of pages prior to the page of the currently-previewed image, there being no page for which the print setting content is different from the print setting content for the last page between the last page and the first page.

6. The image processing apparatus of claim 1, wherein
the input section enables an input of an instruction to set a flag or to delete an already-set flag to one or a plurality of pages included in the print data based on the page of the currently-previewed image, and
the control section performs print processing of the image of the page included in the print data based on the flag.

7. The image processing apparatus of claim 6, wherein the flag is set to the page of the currently-previewed image.

8. The image processing apparatus of claim 6, wherein the flag is set to each of pages from a next page of a last page for which the print setting content is different from the print setting content for the page of the currently-previewed image among a series of pages prior to the page of the currently-previewed image to a previous page of a first page for which the print setting content is different from the print setting content for the page of the currently-previewed image among a series of pages after the page of the currently-previewed image.

9. The image processing apparatus of claim 6, wherein the flag is set to each of pages from a last page for which the print setting content is different from the print setting content for the page of the currently-previewed image to a first page for which the print setting content is same as the print setting content for the last page among a series of pages prior to the page of the currently-previewed image.

10. The image processing apparatus of claim 9, wherein there is no page for which the print setting content is different from the print setting content for the last page between the last page for which the print setting content is different from the print setting content for the page of the currently-previewed image and the first page for which the print setting content is same as the print setting content for the last page among the series of pages prior to the page of the currently-previewed image.

11. The image processing apparatus of claim 1, wherein
the input section enables at least an input of an instruction to change the print setting content for the page of the currently-previewed image, and
the control section allows a display device to perform a display in which a changed portion of the print setting content is visually distinguishable from an unchanged portion of the print setting content.

12. A computer-readable medium storing a program which causes a computer to realize the functions of:
a display function to preview an image to be printed;
an input function to input an instruction to preview a next image; and
a control function to specify an image to be previewed next based on the instruction,
wherein the control section detects a page for which a print setting content is different from a print setting content for the page of a currently-previewed image among a plurality of pages included in print data to determine an image to be previewed next according to a detected result.

13. The computer-readable storage medium of claim 12, wherein an image of a first page for which the print setting content is different from the print setting content for the page of the currently-previewed image among a series of pages after the page of the currently-previewed image is allowed to be the image to be previewed next.

14. The computer-readable storage medium of claim 12, wherein an image of a previous page of the first page for which the print setting content is different from the print setting content for the page of the currently-previewed image among a series of pages after the page of the currently-previewed image is allowed to be the image to be previewed next.

15. The computer-readable storage medium of claim 12, wherein an image of a last page for which the print setting content is different from the print setting content for the page of the currently-previewed image among a series of pages prior to the page of the currently-previewed image is allowed to be the image to be previewed next.

16. The computer-readable storage medium of claim 12, wherein an image of a first page for which the print setting content is same as the print setting content for a last page for which the print setting content is different from the print setting content for the page of the currently-previewed image among a series of pages prior to the page of the currently-previewed image, there being no page for which the print setting content is different from the print setting content for the last page between the last page and the first page, is allowed to be the image to be previewed next.

17. The computer-readable storage medium of claim 12, wherein
the input function inputs an instruction to set a flag or to delete an already-set flag to one or a plurality of pages included in the print data based on the page of the currently-previewed image, and
the control function performs print processing of the image of the page included in the print data based on the flag.

18. The computer-readable storage medium of claim 17, wherein the flag is set to the page of the currently-previewed image.

19. The computer-readable storage medium of claim 17, wherein the flag is set to each of pages from a next page of a last page for which the print setting content is different from the print setting content for the page of the currently-previewed image among a series of pages prior to the page of the currently-previewed image to a previous page of a first page for which the print setting content is different from the print setting content for the page of the currently-previewed image among a series of pages after the page of the currently-previewed image.

20. The computer-readable storage medium of claim 17, wherein the flag is set to each of pages from a last page for which the print setting content is different from the print setting content for the page of the currently-previewed image to a first page for which the print setting content is same as the print setting content for the last page among a series of pages prior to the page of the currently-previewed image.

21. The computer-readable storage medium of claim 20, wherein there is no page for which the print setting content is different from the print setting content for the last page between the last page for which the print setting content is different from the print setting content for the page of the currently-previewed image and the first page for which the print setting content is same as the print setting content for the last page among the series of pages prior to the page of the currently-previewed image.

22. The computer-readable storage medium of claim 12, wherein
the input function inputs at least an instruction to change the print setting content for the page of the currently-previewed image, and
the control function allows a display device to perform a display in which a changed portion of the print setting content is visually distinguishable from an unchanged portion of the print setting content.
